(19) United States
(12) Patent Application Publication
(10) Pub. No.: US 2025/0077901 A1
(43) Pub. Date: Mar. 6, 2025

(54) MULTI-OUTPUT MODEL BASED FORECASTING

(71) Applicant: Oracle International Corporation, Redwood Shores, CA (US)

(72) Inventors: Ankit Kumar Aggarwal, Mumbai (IN); Navya Sree Yadavalli, Guntur (IN); Ravijeet Ranjit Kumar, Bangalore (IN); Hariharan Balasubramanian, Redmond, WA (US); Jie Xing, Redmond, WA (US)

(73) Assignee: Oracle International Corporation, Redwood Shores, CA (US)

(21) Appl. No.: 18/238,708

(22) Filed: Aug. 28, 2023

(51) Int. Cl. G06N 5/022

(52) U.S. Cl. CPC G06N 5/022

(57) ABSTRACT

Techniques for multi-output model forecasting are provided herein. An example method can include a computing system receiving a request to forecast a value for a variable at a future time point based upon a time series, the time series comprising a sequence of data points, each data point in the sequence of data points identifying a time point and at least one value associated with the time point. The computing system can predict, using a first trained machine learning model and based upon the times series, a plurality of forecast values for the future time point, the plurality of forecast values including: a first forecast value forecasted for the variable at the future time point; and a set of one or more forecast attribute values for one or more attributes of the time series, each of the set of one or more forecast attribute values predicted for the future time point.

### BACKGROUND

A cloud service provider (CSP) can provide multiple cloud services to subscribing customers. These services are provided under different models, including a Software-as-a-Service (SaaS) model, a Platform-as-a-Service (PaaS) model, an Infrastructure-as-a-Service (IaaS) model, and others.

The CSP can use a computing infrastructure to offer a forecasting service that can receive a time series from a customer and forecast a value based on the time series. The forecasting service can use a machine learning model to process the time series and generate the forecast value. The forecasting service can configure the machine learning model to adjust the accuracy of the forecast value.

### BRIEF SUMMARY

Embodiments described herein are directed toward a method for multi-output model based forecasting. The method can include receiving, by a computing system, a request to predict a value for a variable at a future time point based upon a time series, the time series comprising a sequence of data points, each data point in the sequence of data points identifying a time point and at least one value associated with the time point.

The method can further include predicting, by the computing system and using a first trained machine learning model and based upon the times series, a plurality of forecast values for the future time point, the plurality of forecast values including: a first forecast value forecasted for the variable at the future time point; and a set of one or more forecast attribute values for one or more attributes of the time series, each of the set of one or more forecast attribute values predicted for the future time point.

Embodiments can further include a computing system, including one or more processors and a computer-readable medium including instructions that, when executed by the processor, can cause the one or more processors to perform operations including receiving a request to predict a value for a variable at a future time point based upon a time series, the time series comprising a sequence of data points, each data point in the sequence of data points identifying a time point and at least one value associated with the time point.

The instructions that, when executed by the one or more processors, can further cause the one or more processors to perform operations including predicting, by the computing system and using a first trained machine learning model and based upon the times series, a plurality of forecast values for the future time point, the plurality of forecast values including: a first forecast value predicted for the variable at the future time point; and a set of one or more forecast attribute values for one or more attributes of the time series, each of the set of one or more forecast attribute values predicted for the future time point.

Embodiments can further include a non-transitory computer-readable medium having stored thereon instructions that, when executed by one or more processors, causes the one or more processors to perform operations including receiving a request to predict a value for a variable at a future time point based upon a time series, the time series comprising a sequence of data points, each data point in the sequence of data points identifying a time point and at least one value associated with the time point.

The instructions that, when executed by the one or more processors, can further cause the one or more processors to perform operations including predicting, by the computing system and using a first trained machine learning model and based upon the times series, a plurality of forecast values for the future time point, the plurality of forecast values including: a first forecast value forecasted for the variable at the future time point; and a set of one or more forecast attribute values for one or more attributes of the time series, each of the set of one or more forecast attribute values predicted for the future time point.

### BRIEF DESCRIPTION OF THE DRAWINGS

FIG. 1 is an illustration of a forecasting system, according to one or more embodiments.

FIG. 2 is an illustration for training a multi-output model, according to one or more embodiments.

FIG. 3 is an illustration for training a regressor model, according to one or more embodiments.

FIG. 4 is an illustration of a forecasting system, according to one or more embodiments.

FIG. 5 is an illustration of a plot of a variance change point, according to one or more embodiments.

FIG. 6 is an illustration of a plot of a mean change point, according to one or more embodiments.

FIG. 7 is an illustration of a plot of a trend change point, according to one or more embodiments.

FIG. 8 is a process flow for generating a forecast value and one or more attribute values, according to one or more embodiments.

FIG. 9 is a process flow for generating a forecast value, according to one or more embodiments.

FIG. 10 is a process flow for generating a forecast value by a regressor model, according to one or more embodiments.

FIG. 11 is a block diagram illustrating one pattern for implementing a cloud infrastructure as a service system, according to at least one embodiment.

FIG. 12 is a block diagram illustrating another pattern for implementing a cloud infrastructure as a service system, according to at least one embodiment.

FIG. 13 is a block diagram illustrating another pattern for implementing a cloud infrastructure as a service system, according to at least one embodiment.

FIG. 14 is a block diagram illustrating another pattern for implementing a cloud infrastructure as a service system, according to at least one embodiment.

FIG. 15 is a block diagram illustrating an example computer system, according to at least one embodiment.

### DETAILED DESCRIPTION

In the following description, various embodiments will be described. For purposes of explanation, specific configurations and details are set forth in order to provide a thorough understanding of the embodiments. However, it will also be apparent to one skilled in the art that the embodiments may be practiced without the specific details. Furthermore, well-known features may be omitted or simplified in order not to obscure the embodiment being described.

A cloud services provider (CSP) can provide a service for analyzing a time series to understand the behavior of the time series. Once a CSP forecasting service can identify patterns in the time series, the forecasting service can use the patterns to forecast values for future dates. One issue for forecasting services is that the accuracy of the forecast can be based on the identification of useful features in the time series. If a CSP forecasting service chooses the wrong features, the accuracy of the forecast can be impacted.

The herein-described embodiments describe a forecasting methodology based on a multi-output model that can be trained to perform multiple forecasting-related tasks. The multi-output model can be trained to receive a time series and forecast a value for a future time point. The multi-output model can further be trained to determine one or more attributes of the forecast value. The attributes can include whether or not the forecast value is a change point. If the multi-output model determines that the forecast value is a change point, then the model can further determine one or more attributes of the change point. For example, is the change point a seasonality change point, a trend change point, a variance change point, or some other change point attribute? The multi-output model can further determine a direction of the shift indicated by the change point. For example, if the forecast value is a trend change point, the multi-output model can determine whether the shift at the change point is a shift from an upward trend to a downward trend or a shift from a downward trend to an upward trend.

The multi-output model can transmit the determinations, including the forecast value, the change point attribute, and the change point shift direction to a second model. The second model can use the change point attribute and the change point shift direction attribute determinations to evaluate the forecast value, and update the forecast value to improve its accuracy, if warranted.

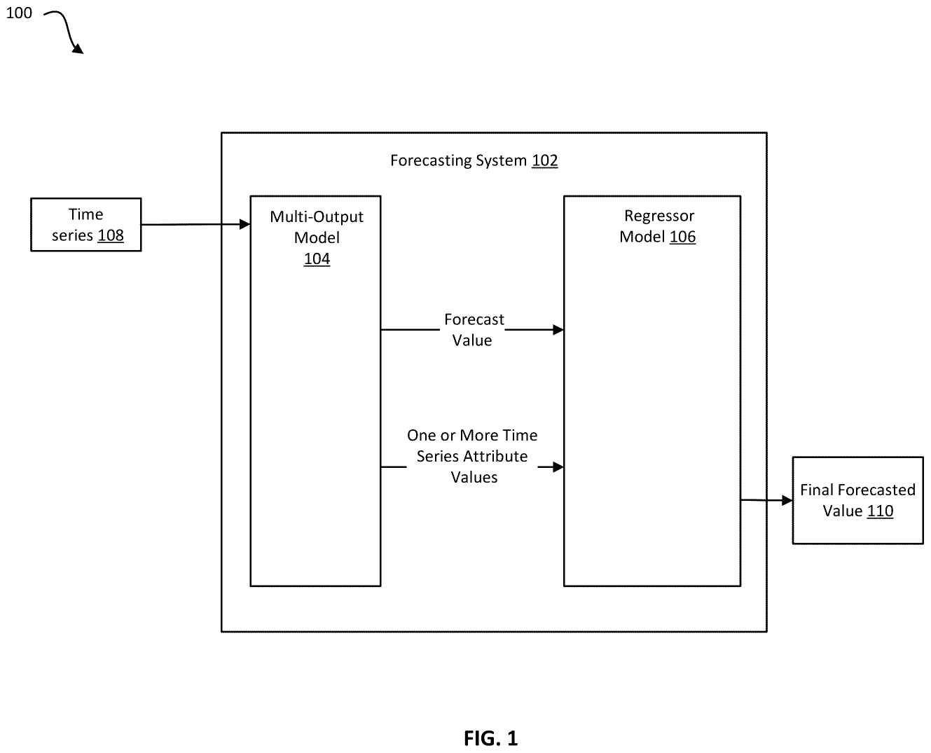

FIG. 1 is an illustration 100 of a forecasting system, according to one or more embodiments. The forecasting system 102 can include a multi-output model 104 and a regressor model 106 and be part of a service offered by a CSP. The forecasting system 102 can be implemented using a cloud infrastructure as described herein. The multi-output model 104 can be trained to perform multiple forecasting-related tasks, such as forecasting a future value based upon a time series 108 and determining one or more attributes of the forecast value. For example, the forecasting system 102 can receive the time series 108 and instructions to forecast a value for a future time point. The multi-output model 104 can include a neural network having one or more neural network layers trained to determine a forecast value for the requested future time point.

The multi-output model 104 can further be trained to determine one or more attribute values of the forecast value. One attribute can be determining whether the forecast value is a change point. A change point can be indicative of a shift in statistical property at a single data point, rather than a change over a sequence of data points. The multi-output model 104 can include one or more neural network layers that can implement a change point detection algorithm (e.g., bottom-up segmentation, dynamic programming, Bayesian online, pruned exact linear time (PELT), kernel change direction, or binary segmentation) to determine whether any of the data points in the time series are change points. The multi-output model can further predict whether the forecast value is a change point. For example, the multi-output model can use the determined change points in the time series to help determine whether the forecast value is a change point. In other words, the multi-output model 104 can be trained to determine whether there will be a change point at a future time point.

In the event that a forecast value is not a change point, the multi-output model 104 can discontinue determining if the forecast value has any other attributes. If, however, the multi-output model 104 determines that the forecast value is a change point, the model can determine additional attributes of the forecast value. One additional attribute can be the type of change point. The multi-output model 104 can be trained to use one or more change point algorithms for detecting various types of change points. For example, the multi-output model 104 can determine that a forecast value is a mean shift change point. The time series values up to the forecast value can be characterized as having a uniform standard deviation and constant mean value. After the forecast value, the multi-output model can predict that the time series values can be characterized as having the same standard deviation, but a different mean. Therefore, the multi-output model 104 can be trained to determine the change point type of a future time point without the benefit of the data points that occur after the forecast value. This would be in contrast to determining a change point in historical data, in which the computing system would have the benefit of the data points occurring before the determined change point and after the determined change point. The multi-output model 104 can use various change point detection algorithms because some change point detection algorithms are better at detecting certain types of change points than other algorithms.

Another attribute that the multi-output model 104 can be trained to determine a direction of the shift described by the change point. As indicated above, the change point can be indicative of a change in a statistical property of the time series. The direction of the shift can be indicative of how the statistical property is changing. For example, the multi-output model 104 can determine that a segment of the time series leading up to the forecast value exhibits an upward trend. The multi-output model can further determine that the time series shifts to a downward trend at a forecast value. In this example, the multi-output model 104 can determine that the direction of the shift is a downward direction. If, however, the multi-output model 104 had determined that the time series exhibit a downward trend, which shifts to an upward trend at a change point, the multi-output model 104 can determine an upward direction for the shift. Similar to determining the change point type, the multi-output model 104 can determine the shift at the forecast value without the benefit of the data points that would occur after the forecast value.

The multi-output model 104 can output each of the determinations (e.g., forecast value, change point type, and shift direction) as binary values. For example, the multi-output model 104 can output the forecast value in binary format. Additionally, the multi-output model 104 can output an attribute type as a binary value. For example, if the change point is a trend change point, the multi-output model 104 can output a logical 1. If, however, the shift at the change point is not a trend shift, the multi-output model can output a logical 0. Additionally, the multi-output model 104 can output the direction of the shift as a binary value. For example, if a trend shift is an upward trend, the multi-output model 104 can output a logical 1. If the trend shift is a downward trend, the multi-output model 104 can output a logical 0. In this sense, the multi-output model 104 can receive an analog signal (e.g., time series) as an input and output multiple values in binary format.

It should be appreciated that each of the attributes corresponds to a particular future time point. For example, the multi-output model 104 can receive values at time points T−2, T−1, and T, where T is the present time. The multi-output model 104 can further receive instructions to forecast a value at future time point T+1. The forecast value and the attribute values correspond to the future time point T+1. In some instances, the instructions are to forecast values for multiple future time points. For example, the multi-output model 104 can receive instructions to forecast values at future time points T+1 and T+2. In this example, the multi-output model 104 can output forecast values and attribute values for future time points T+1 and T+2 based upon the values at T−2, T−1, and T.

The multi-output model 104 can be a deep-learning model. A deep-learning model can be a model that is trained to process information similar to the human brain. The deep-learning model deep-learning model deep-learning model can be architecture agnostic and include various architectures, such as a convolutional neural network (CNN), long short-term memory (LTSM) network, transformer neural network, and fully connected neural network. The deep-learning model can include neural network layers that are configured to execute algorithms. The deep-learning model can include an input layer for receiving a time series in the form of an analog signal. The deep-learning model can further include hidden layers that are divided into different sets of layers, in which each layer set is configured to receive signals from the input layer and perform a forecasting-related task. The deep-learning model can further include an output layer for receiving signals from the hidden layers and outputting the determination, such as the forecast value, the change point attribute, and a change point attribution direction.

The multi-output model 104 can transmit the forecast value and attribute values to regressor model 106. The regressor model 106 can be trained to receive the forecast value and the one or more attributes and determine whether to update the forecast value. It should be appreciated that in some instances, the regressor model 106 can determine that the forecast value generated by the multi-output model 104 is a final forecast value. In other instances, the regressor model 106 can determine to update the forecast value generated by the multi-output model 104 based upon the one or more attribute values as a forecast value being a change point and the associated shift effects may alter the forecast value generated by the multi-output model 104.

The regressor model 106 can be coupled to circuitry to further compare the forecast value generated by the multi-output model 104 to the forecast value determined by the regressor model 106. If the forecast values are greater than a threshold distance apart, the regressor model 106 can output the forecast value determined by the regressor model 106. If the forecast values are less than a threshold distance apart, the regressor model 106 can output the forecast value generated by the multi-output model 104.

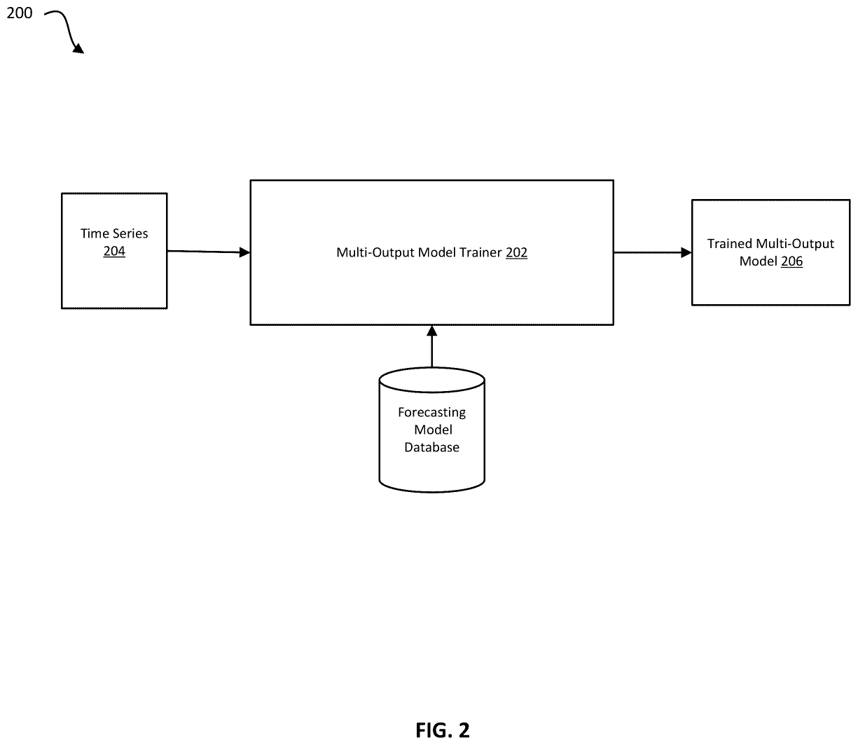

FIG. 2 is an illustration 200 for training a multi-output model, according to one or more embodiments. As illustrated, the multi-output model trainer 202 can receive a time series 204 as an input and generate a trained multi-output model 206. The time series 204 can be a temporal sequence of data points measuring a parameter (e.g., weather, temperature) over a time interval. The multi-output model trainer 202 can receive the time series 204 and divide the time series into a training set and a testing set. For example, if the time series 204 includes monthly data points for ten years, the multi-output model trainer 202 can divide the time series 204 into the first eight years as the training set and the last two years as the testing set. The testing set can be used as ground truth data. The time series can further be an annotated time series, such that the time series is annotated to indicate the change points, the change point types, and the change point shift directions. The annotations can also be used by the multi-output model trainer 202 as ground truth data.

The multi-output model trainer 202 can retrieve a model from a forecasting model database 208. The model can be a pre-trained model or a model that is to be trained from scratch. In some embodiments, the model can be a deep learning model. The multi-output model trainer 202 can train the model using the training set. The multi-output model trainer 202 can train the model to be a multi-task model that can output a forecast value using the time series and, additionally, output one or more attribute values.

The multi-output model trainer 202 can train the model to use the time series 204 and forecast a value for a future time point. In addition to the forecast value, the multi-output model trainer 202 can train the model to output one or more attribute values. The attribute values can be based upon the forecast value. In other words, the model is trained to determine an attribute of a forecast value.

The multi-output model trainer 202 can train the model to use a change point detection algorithm (e.g., bottom-up segmentation, dynamic programming, pruned exact linear time (PELT), kernel change direction, or binary segmentation) to determine whether the forecast value is a change point. If the forecast value is not a change point, then the model does not need to determine any more attributes. If, however, the value is not a change point, the multi-output model trainer 202 can train the model to not need to determine any more attribute values.

If the forecast value is a change point, then the multi-output model trainer 202 can train the model to determine additional attribute values. The attribute values can relate to a type of change point and a direction of the attribute. The types of change points can include, but not be limited to, a level change point type, a trend change point type, a variance change point type, and a seasonality change point type. In some instances, a forecast value may appear to be a change point, but is, in fact, an outlier. Therefore, the multi-output model trainer 202 can train the model to determine whether the forecast value is an outlier.

The multi-output model trainer 202 can further train the model to output the determination of the change point type as a binary output (e.g., a logical 1 or a logical 0). For example, the multi-output model trainer 202 can train the model to determine whether the forecast value is a level change point type, a trend change point type, or a variance change point type. During the training process, the multi-output model trainer 202 can determine that the forecast value is not a level change point type, is a trend change point type, and is not a variance change point type. In this instance, the model can output a logical 0 or 1, where a 0 is a false and a 1 is a true. In another instance, the model had determined that the forecast value is a level change point type, is not a trend change point type, and is not a variance change point type. In this instance, the model can output a logical 1, 0, and 0.

The multi-output model trainer 202 can further train the model to determine a direction of a shift at the change point. As indicated above, the direction of the attribute can shift at the change point. The direction can be characterized as a binary direction choice. For example, if the model determines that the forecast value is a seasonality change point type, the model can further determine a shift in the direction of the seasonality. For example, the seasonality can shift from an increasing seasonal length to a decreasing seasonal length. In another example, the seasonality can shift from a decreasing seasonal length to an increasing seasonal length.

The multi-output model trainer 202 can further train the model to output the determination of the direction of the shift as a binary output (e.g., a logical 1 or a logical 0). For example, during the training process, the model can determine that the change point type of the forecast value is a variance change point type. The model can further determine that the standard deviation of the data point changed at the change point. The model can further output a binary value (e.g., a logical 1) if the standard deviation shifts to a larger standard deviation at the change point. Additionally, the model can output another binary value (e.g., a logical 0) if the standard deviation shifts from a larger to a smaller standard deviation at the change point. It should be appreciated that the regressor model can be trained to recognize the definition of each of the outputted binary values.

The multi-output model trainer 202 can further use the testing data to determine the accuracy of the model. The multi-output model trainer 202 can use an evaluation metric (e.g., a mean absolute scaled error (MASE) evaluation metric) to determine the accuracy of the model. The multi-output model trainer 202 can execute the model to generate multiple outputs, such as a forecast value and one or more attribute values. The multi-output model trainer 202 can then test the accuracy against the testing set. If the multi-output model trainer determines that the accuracy is not at a target accuracy, the multi-output model trainer 202 can use backpropagation to adjust the weights of the model. The multi-output model trainer 202 can then use the training data to re-execute the model and then retest the accuracy against the testing set. If the output accuracy is still not at the target accuracy, the multi-output model trainer 202 can readjust the weights and perform the testing process again.

The complexity of the trained multi-output model 206 can correlate to the improved accuracy of the forecast value. A traditional deep learning model can be trained to receive a time series as an input and output a forecast value. Therefore, during the training process, the backpropagation results in adjusting the weights for only one task-forecasting a value for a future time point. As described-herein the multi-output model is trained to perform multiple tasks-outputting a forecast value, determining change points in the time series, determining whether a forecast value is a change point, determining the change point type(s), and determining the change point direction shift(s). Therefore, during the training process, the backpropagation results in adjusting the model's weights for multiple tasks. The added complexity of the final weights of the trained multi-output model 206 helps improve the accuracy of the forecast value over traditional forecasting models.

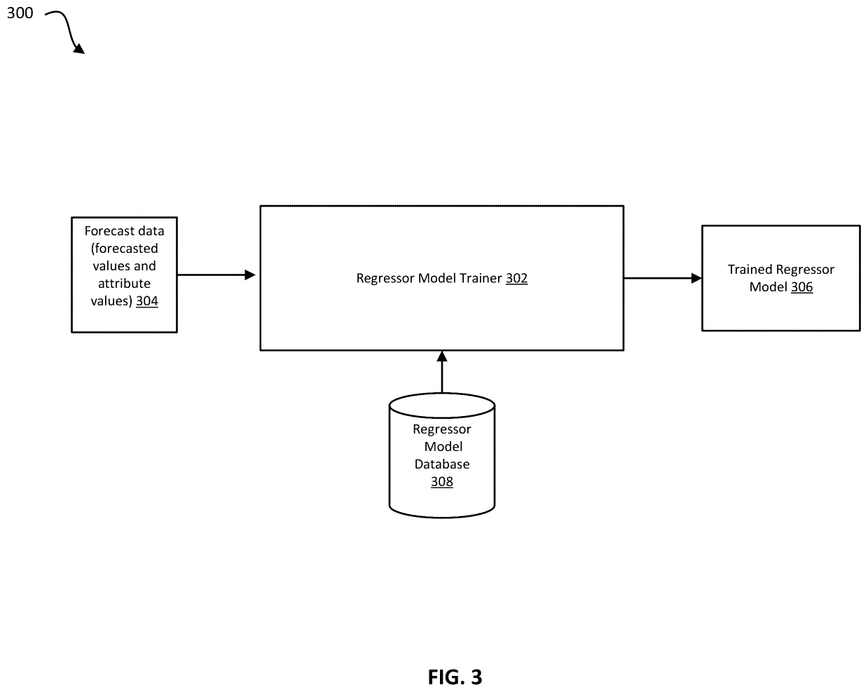

FIG. 3 is an illustration 300 for training a regressor model, according to one or more embodiments. As illustrated, the regressor model trainer 302 is operable to receive forecast data 304, including forecast values and attribute values, and generate a trained regressor model 306. The multi-output model trainer 202 can train a multi-output model independently from the regressor model trainer 302 training a regressor model. In some instances, the CSP, or other entity, can train both a multi-output model and a regressor model. Therefore, the CSP can have access to the outputs of the trained multi-output model 206. In some instances, the forecast data 304 can be the output of the trained multi-output model 206 generated during the training process. In other instances, the forecast data 304 can be data received from another source, or a combination of the output of the trained multi-output model 206 and data received from another source.

The regressor model trainer 302 can retrieve a model from a forecasting model database 208. The model can be a pre-trained model or a model that needs to be trained from scratch. The regressor model trainer 302 can then use the training set to train a model to receive a forecast value and one or more attribute values and forecast a value. The regressor model trainer 302 can use the test set as ground truth to determine the accuracy of the forecasts. The regressor model trainer 302 can further use backpropagation to adjust the weights of the model based upon the testing.

As indicated above, the regressor model can be a GBM, such as a LightGBM model. Gradient boosting can be a technique for regression and classification issues, and used to generate a predictive model (e.g., GBM) that includes multiple weak predictive models, such as decision trees. To train a GBM to generate a forecast value, the regressor model trainer 302 can access a GBM function stored in a GBM library. The regressor model trainer 302 can further define the predictor variables. The regressor model trainer 302 can then define the distribution (e.g., Gaussian distribution, Poisson distribution). The regressor model trainer 302 can then define the data and the number of trees to be generated. The regressor model trainer 302 can then divide the forecast data 304 into a training set and a testing set. The testing set can be considered ground truth data.

The regressor model trainer 302 can train a decision tree using each observation of the time series (e.g., forecast value and one or more attribute values) and each observation can be assigned an equal weight. The regressor model trainer 302 can analyze the decision tree and generate a new decision tree by adjusting the weights by increasing certain weights and decreasing certain weights. The forecasting system can then calculate a classification error and generate a third decision tree. The regressor model trainer 302 can then repeat this process for a set number of times to generate the GBM, which includes the generated decision trees. The regressor model trainer 302 can use the GBM to generate the forecast value for the future time point. The regressor model trainer 302 can further use backpropagation to adjust (sometimes referred to as “Early Stopping” the GBM's weights based upon the testing. The regressor model trainer 302 can tune iterations of the GBM based upon the GBM's performance against the testing data. The regressor model trainer 302 can stop adjusting the GBM's weights as the adjusting begins to show negligible improvement of the performance of the forecasting.

In addition to outputting the forecast value, the trained GBM can output information as to which variables contributed to the updated value and which variables did not. For example, one of the attribute values can be a shift direction for a seasonality type change. The trained GBM can output the number of decision trees used to generate the forecast value. The trained GBM can output information indicating whether or not the shift direction value contributed to the forecast value. The trained GBM can further output information as to the relative importance of each variable that did contribute to the forecast value.

In other instances, a regressor model can be trained for other forms of regression analysis, such as Lasso Regression, Partial Least Squares (PLS), Support Vector Regression, Bayesian Regression, or other supervised ML technique that can use a loss function (e.g., root mean square error) for training.

The regressor model's accuracy can be improved based upon training the model to receive and process the multi-output model's outputs. The regressor model can leverage insights from the attribute information for the forecast value to improve the accuracy of the forecast value.

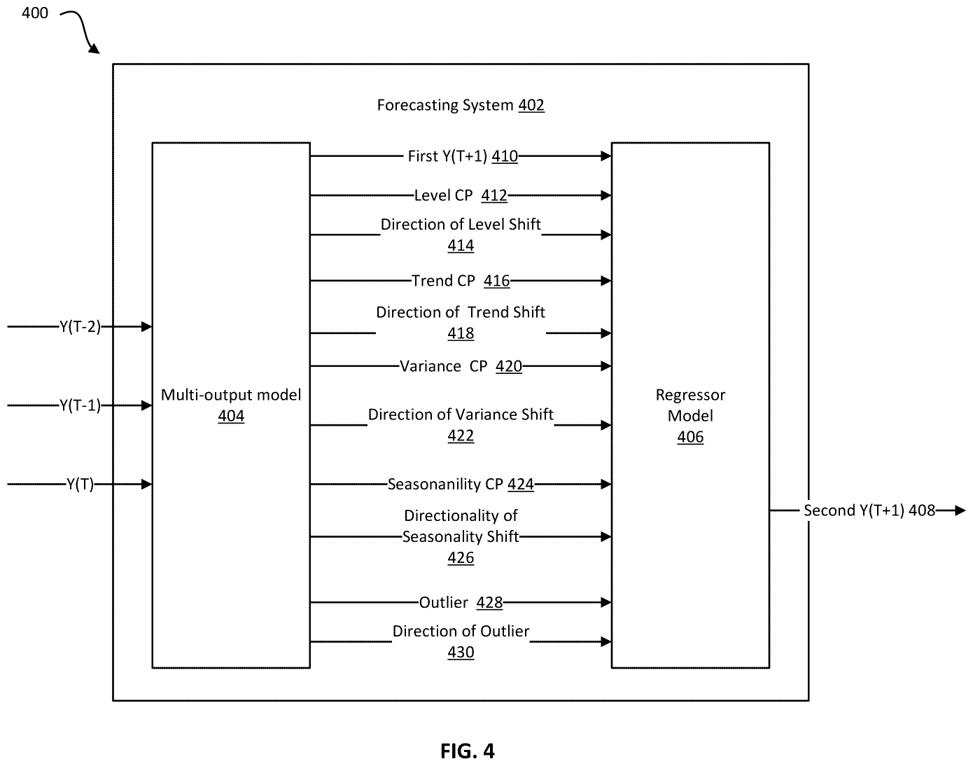

FIG. 4 is an illustration 400 of a forecasting system, according to one or more embodiments. As illustrated, the forecasting system 402 can include a multi-output model 404 and a regressor model 406. The forecasting system 402 can be trained to receive time series as an input and output a second Y(T+1) 408. In some embodiments, the multi-output model 404 can be trained to output a forecast value that correlates to different lags, where a lag is a value of the time gap that is being considered. For example, as illustrated, the multi-output model 404 is seen outputting a forecast value, first Y(T+1) 410 based upon the three input data points (Y(T−2), Y(T−1), and (Y(T)). As there are three inputs from Y(T−2)−Y(T), the lag can be three. If, for example, there were four inputs (e.g., Y(T−3)−Y(T)), the lag would be four, and first Y(T+1) 410 would correlate to the four inputs.

The multi-output model 404 is further seen outputting a forecast value, Y(T+1) based upon the three inputs. The multi-output model 404 is further seen outputting multiple attribute values. As indicated above, the multi-output model 404 can be trained to implement a change point detection algorithm (e.g., bottom-up segmentation, dynamic programming, pruned exact linear time (PELT), to determine whether the forecast value, first Y(T+1) 410 is a change point. In some instances, the multi-output model 404 can determine that the forecast value, first Y(T+1) 410 is not a change point. In this instance, the change point attributes can out a value indicative of the determination that the forecast value, first Y(T+1) 410 is not a change point.

In some instances, the multi-output model 404 can determine that the forecast value, first Y(T+1) 410 is a change point. In these instances, the multi-output model 404 can be trained to determine additional attribute values. The multi-output model 404 can determine whether the forecast value, first Y(T+1) 410 is a level change point 412. The multi-output model 404 can determine the direction of the level shift 414 (e.g., an upward shift or a downward shift). The multi-output model 404 can determine whether the forecast value, first Y(T+1) 410 is trend change point 416. The multi-output model 404 can determine a direction of the trend shift 418 (e.g., shifting upward or shifting downward). The multi-output model 404 can determine whether the forecast value, Y(T+1) 410, is a variance change point 420. The multi-output model 404 can determine the direction of the variance shift 422 (e.g., an increasing variability or decreasing variability). The multi-output model 404 can determine whether the forecast value, Y(T+1) 410, is a seasonality change point 424. The multi-output model 404 can determine the direction of the seasonality shift 426 (e.g., an increasing seasonal length or a decreasing seasonal length). The multi-output model 404 can determine whether the forecast value, Y(T+1) 410, is an outlier 428. The multi-output model 404 can determine a direction of the outlier 430 (e.g., a positive direction or negative direction). The multi-output model 404 is not limited to the ten illustrated attributes, and the multi-output model 404 can be trained to output other attribute values that describe a change point-related attribute of the forecast value.

The multi-output model 404 can be trained to output the attribute values as binary values (e.g., logical 1s or 0s). For example, if the multi-output model 404 determines that the forecast value, Y(T+1) 410, is a trend change point 416, then the attribute value can be a 1. Furthermore, the attribute values for level change point 412, variance change point 420, seasonality change point 424, an outlier can be logical 0s. Furthermore, the attribute value for the direction of the trend shift can be a binary number (e.g., a logical 1 or 0) depending on whether the shift is an upward trend or a downward trend. As the forecast value, Y(T+1) 410, is a trend change point 416, there is no direction shift for the other types of change points. Therefore, the attribute values for the direction of the other types of change points can be a null value.

In some instances, the multi-output model 404 can determine that the forecast value, first Y(T+1) 410 is more than one change point type. In these instances, the multi-output model 404 can output signals that indicate that the forecast value is more than one type of change point. The multi-output model 404 can further output signals that indicate the direction shift for each change point type.

As illustrated, the regressor model 406 can receive the outputs of the multi-output model 404. The regressor model 406 can be trained to generate a forecast value based upon the outputs from the multi-output model 404. The regressor model 406 can be coupled to circuitry to further compare the forecast value, first Y(T+1) 410 generated by the multi-output model 404 to the forecast value determined by the regressor model 408. If the forecast values are greater than a threshold distance apart, the regressor model 406 can output the forecast value determined by the regressor model 406. If the forecast values are less than a threshold distance apart, the regressor model 106 can output the forecast value, first Y(T+1) 410 generated by the multi-output model 104.

In some instances, the forecasting system 402 has received a request to forecast values for more than one future time point. For example, the forecasting system 402 can receive a request to forecast values for future time points T+1 and T+2. In these instances, the regressor model can feedback the forecast value, second Y(T+1) 408 back into the multi-output model 404. The multi-output model 404 can be configured to maintain the current lag value. As illustrated, the multi-output model 404 is configured to receive time series values with a lag of three. Therefore, rather than receive Y(T−2), Y(T−1), and Y(T) as inputs, the multi-output model 404 can receive Y(T−1), Y(T), Y(T+1) as inputs. Furthermore, rather than output Y(T+1) 410, the multi-output model 404 can output the forecast value Y(T+2). As to the attribute values, the multi-output model 404 can determine the attribute values as to the forecast value Y(T+2). The multi-output model 404 can output the forecast value Y(T+2) and the attribute values to the regressor model 406, which can determine a forecast value for T+2 and determine whether to output Y(T+2) as determined by the multi-output model 404 or output an updated forecast value for the time point T+2 as described above.

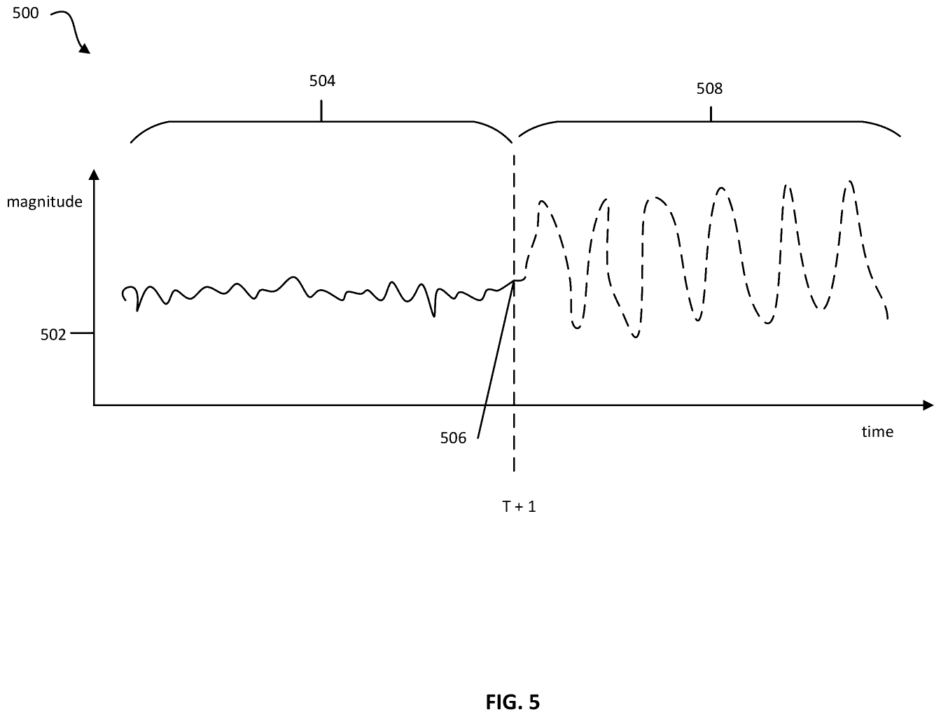

As indicated above, there are different categories of change points. FIGS. 5-7 illustrate some different categories of change points. FIG. 5 is an illustration of a plot 502 of a variance change point, according to one or more embodiments. As illustrated, a time series 504 includes a waveform representative of a magnitude of a parameter over time. A multi-output model has used a change point detection algorithm to determine a change point 506 at a future time point T+1. The multi-output model has further determined a category of the change point 506 can as a variance change point. In other words, the multi-output model predicts that the variance of the time series 504 is going to shift for future data points 508. It can be seen that the data points to the left of the change point 506 have a smaller variance than the data points to the right of the change point 506. The multi-output model can further determine a direction of the shift. As illustrated, the standard deviation has been predicted to increase at the change point 506 and therefore, the multi-output model can out a signal (e.g., a logical 1) to indicate that the direction of the standard deviation at the change point 506 has been predicted to increase. If, for example, the multi-output model had predicted the standard deviation would decrease at the change point 506, the multi-output model could output a signal (e.g., a logical 0) to indicate that the direction of the standard deviation at the change point 506 has been predicted to decrease.

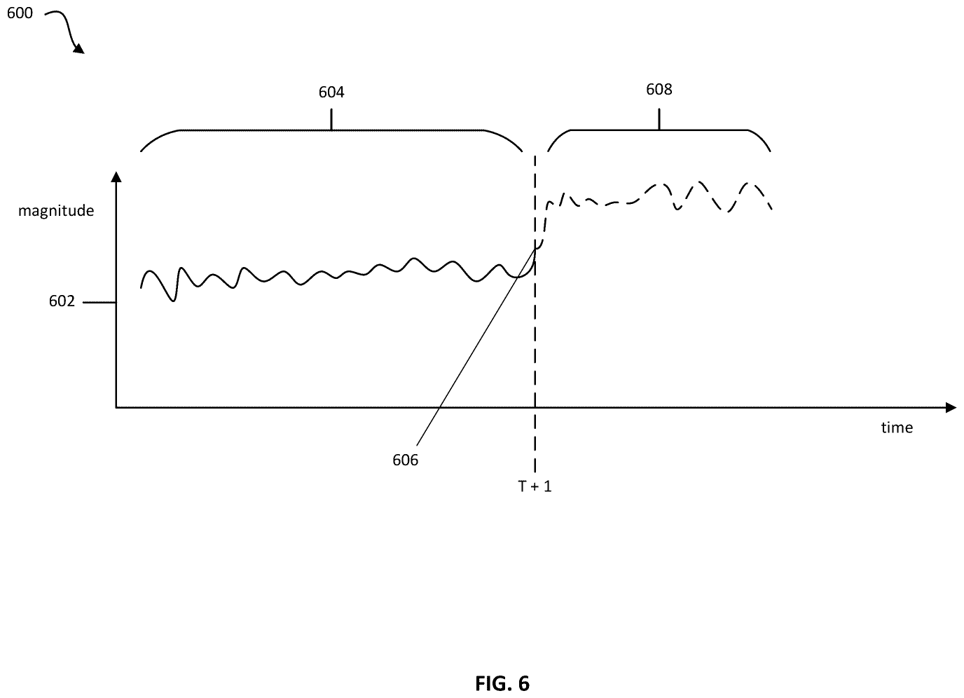

FIG. 6 is an illustration 600 of a plot 602 of a mean change point, according to one or more embodiments. As illustrated, a time series 604 includes a waveform representative of a magnitude of a parameter over time. A multi-output model has used a change point detection algorithm to determine a change point 606 at a future time point T+1. The multi-output model has further determined a category of the change point 606 can as a mean change point. In other words, the multi-output model is predicts that the mean of the time series 604 is going to shift for future data points 608. It can be seen that the data points to the left of the change point 606 have a lower mean than the data points to the right of the change point 606. The multi-output model can further determine a direction of the shift. As illustrated, the mean has been predicted to increase at the change point 606 and therefore, the multi-output model can out a signal (e.g., a logical 1) to indicate that the mean at the change point 606 is predicted to increase. If, for example, the multi-output model had predicted the direction of the mean would decrease at the change point 606, the multi-output model could output a signal (e.g., a logical 0) to indicate that the direction of the mean at the change point 606 has been predicted to decrease.

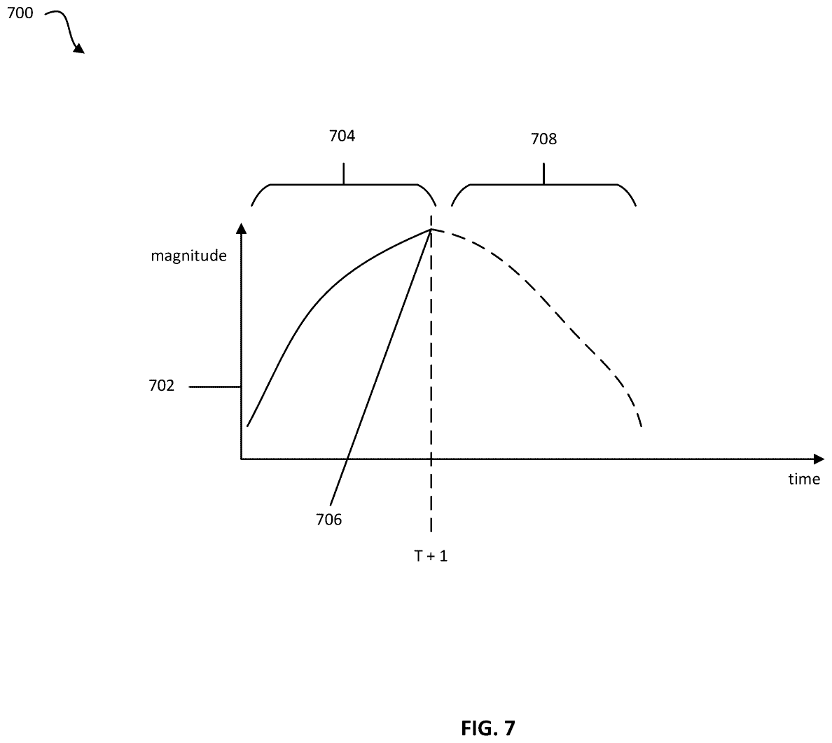

FIG. 7 is an illustration 700 of a plot 702 of a trend change point, according to one or more embodiments. As illustrated, a time series 604 includes a waveform representative of a magnitude of a parameter over time. A multi-output model has used a change point detection algorithm to determine a change point 706 at a future time point T+1. The multi-output model has further determined a category of the change point 706 as a trend change point. In other words, the multi-output model is predicts that the trend of the time series 704 is going to shift for future data points 708. It can be seen that the data points to the left of the change point 706 have an upward trend and the data points to the right of the change point 706 have a downward trend. The multi-output model can further determine a direction of the shift. As illustrated, the trend has been predicted to shift to a downward trend at the change point 706 and therefore, the multi-output model can out a signal (e.g., a logical 0) to indicate that the trend at the change point 706 is predicted to decrease. If, for example, the multi-output model had predicted the direction of the mean would decrease at the change point 706, the multi-output model could output a signal (e.g., a logical 1) to indicate that the direction of the trend at the change point 706 has been predicted to be an upward trend.

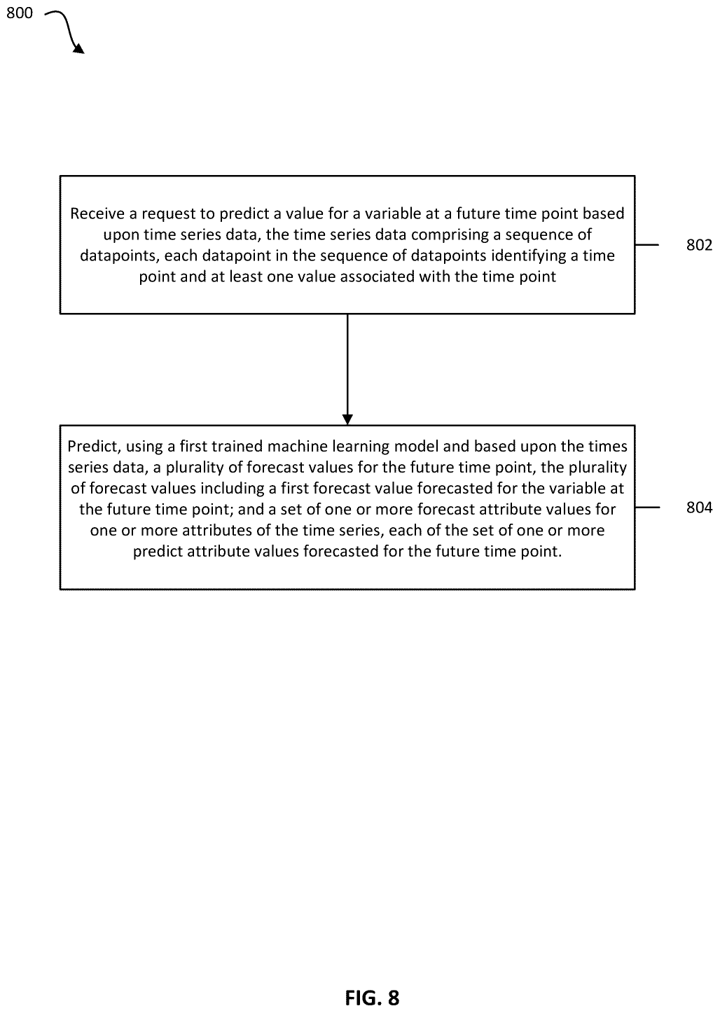

FIG. 8 is a process flow 800 for generating a forecast value and one or more attribute values, according to one or more embodiments. While the operations of processes 800 and 900 are described as being performed by generic computers, any suitable device (e.g., a cloud services provider server) may be used to perform one or more operations of these processes. Processes 800 and 900 (described below) are respectively illustrated as logical flow diagrams, each operation of which represents a sequence of operations that can be implemented in hardware, computer instructions, or a combination thereof. In the context of computer instructions, the operations represent computer-executable instructions stored on one or more computer-readable storage media that, when executed by one or more processors, perform the recited operations. Generally, computer-executable instructions include routines, programs, objects, components, data structures, and the like that perform functions or implement data types. The order in which the operations are described is not intended to be construed as a limitation, and any number of the described operations can be combined in any order and/or in parallel to implement the processes.

At 802, the method can include a computing system (e.g., a forecasting system) receiving a request to forecast a value for a variable at a future time point based upon a time series. The time series can comprise a sequence of data points, where each data point in the sequence of data points identifies a time point and at least one value associated with the time point.

At 804, the method can include the computing system forecasting, using a first trained machine learning model, a plurality of forecast values for the future time point. The first trained machine learning model can be a multi-output model that is implemented as a deep learning model that is trained to receive the time series and output the plurality of forecast values based upon the time series. The deep learning model can be trained by adjusting a plurality of weights of the deep learning model to determine a change point at the future time point, determine a change point type at the future time point, and determine a change point shift direction at the future time point The plurality of forecast values can include a first forecast value (e.g., a first forecast value) forecasted for the variable at the future time point (e.g., T+1). The plurality of forecast values can further include a set of one or more forecast attribute values for one or more attributes of the time series. Each of the set of one or more forecast attribute values is forecasted for the future time point.

With respect to the plurality of forecast values, the computing system can determine that the first forecast value is a change point (e.g., a level change point, a trend change point, a variance change point, a seasonality change point). In some instances, the computing system can determine that the first forecast value is an outlier. The computing system can further determine one or more change point attributes of the first forecast value based upon determining that the first forecast value is a change point. The computing system can further determine the set of one or more forecast attribute values based upon the one or more change point attributes, wherein each forecast attribute value of the set of one or more forecast attributes values describes a change in a respective change point attribute.

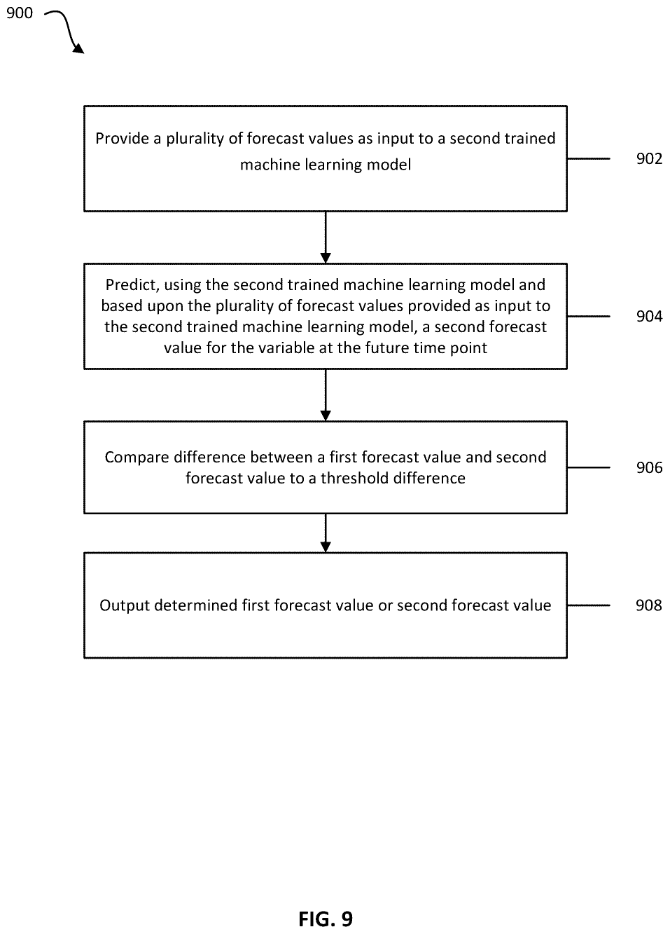

FIG. 9 is a process flow 900 for generating a forecast value, according to one or more embodiments. At 902, a computing system (e.g., a forecasting system) can provide a plurality of forecast values (e.g., the plurality of forecast values forecasted at 804 above) as input to a second trained machine learning model. The second trained machine learning model can be a regressor model that is trained to receive the plurality of forecast values and output a forecast value based upon the plurality of forecast values. The regressor model can be trained by adjusting a plurality of weights of the regressor model to determine a second forecast value based upon the first forecast value, a change point type at the future time point, and a change point shift direction at the future time point.

At 904, the computing system can use the second trained machine learning model and based upon the plurality of forecast values provided as input to the second trained machine learning model, forecast a second forecast value for the variable at the future time point. In particular, the second trained machine learning model can generate, using the plurality of forecast values, the second forecast value forecasted for the variable at the future time point. The second trained machine learning model can be coupled to circuitry to compare a difference between the first forecast value and the second forecast value to a threshold difference.

At 906, the second trained machine learning model can determine whether to output the first forecast value or the second forecast value based upon comparing the difference between the first forecast value and the second forecast value to the threshold difference. For example, if the second forecast value is greater than a threshold distance apart from the first forecast value, the second trained machine learning model can determine to output the second forecast value determined by the second trained machine learning model. If, however, the second forecast value is less than a threshold distance apart than the first forecast value, the second trained machine learning model can determine to output the first forecast value generated by the first trained machine learning model.

At 908, the computing system can output the determined first forecast value to the second forecast value in response to a request (e.g., the request of 802 above).

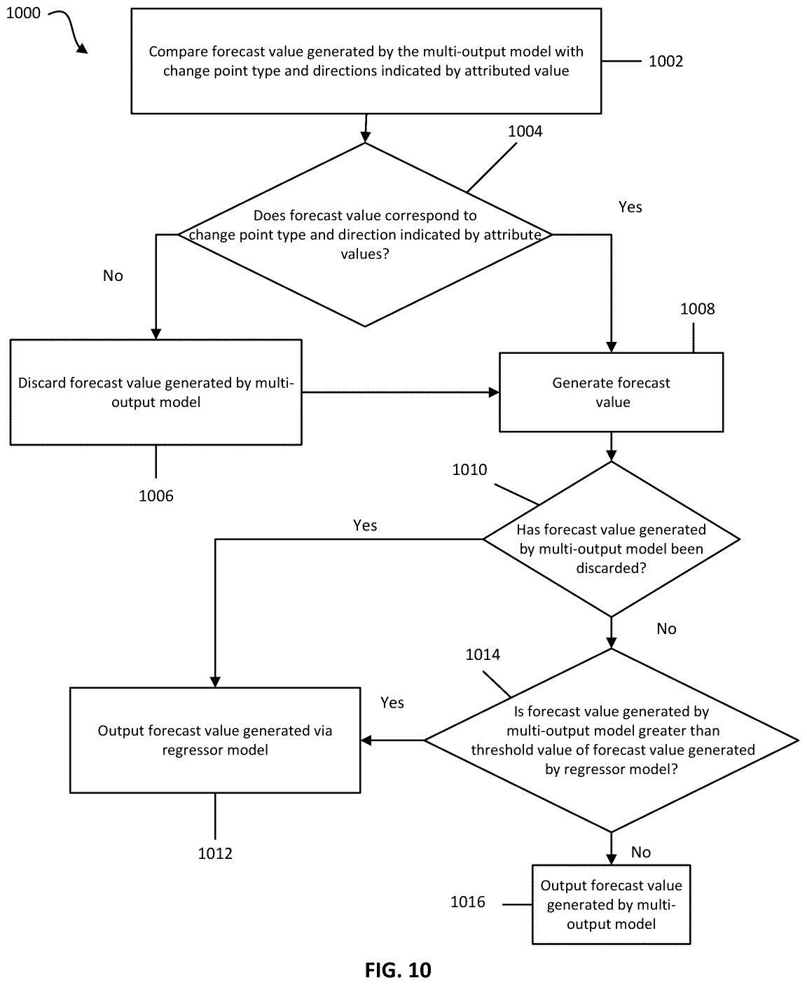

FIG. 10 is a process flow for generating a forecast value by a regressor model, according to one or more embodiments. At 1002, a computing system (e.g., a computing system implementing a regressor model) can compare a forecast value generated by a multi-output model with a change point type and direction as indicated by attribute values generated by the multi-output model.

At 1004, the computing system can determine whether the forecast value corresponds to a change point type and direction as indicated by the attribute values. A change point can have characteristics associated with a change point type. For example, referring to FIG. 7, the forecasted change point 706 at time point T+1 is indicative of a shift in trend from an upward trend to a downward trend. Additionally, referring to FIG. 6, the forecasted change point 606 at time point T+1 is indicative of an upward shift in a mean value of the time series 604. The change in magnitude from the data point of the time series 704 at time point T to the change point 706 may not be as dramatic for a trend change point as the change in magnitude from the data point of the time series 604 at time point T to the change point 706 for a mean change point. Each change point type can have characteristics that assist the computing system determine whether the forecast value corresponds to a change point type. Therefore, the computing system can be configured to determine whether the forecast value has one or more characteristics that correspond with the change point type.

The computing system can also determine whether the direction of the forecast value corresponds to the direction indicated by the attribute value. For example, referring to FIG. 6 the forecasted change point 606 is illustrated to have an upward shift. Therefore, the magnitude of the forecasted change point 606 at time point T+1, can be expected to be higher than the magnitude of a data point at time point T. Therefore, the computing system can determine whether the magnitude of the forecasted change point corresponds with the forecasted direction shift of the change point.

At 1006, if the computing system determines that the forecast value does not correspond to the change point type and direction, the computing system can discard the forecast value generated by the multi-output model.

At 1008, if the computing system either determines that the forecast value corresponds with the change point type and direction at 1004, or the computing system discards the forecast value generated by the multi-output model at 1006, the computing system can generate (via the regressor model) a forecast value.

At 1010, the computing system can determine whether the forecast value generated by the multi-output model has been discarded at 1006. If the forecast value generated by the multi-output model has been discarded at 1006, the computing system can output the forecast value generated via the regressor model at 1012.

If the forecast value generated by the multi-output model has not been discarded at 1006, the computing system can determine whether the difference between the forecast value generated by the multi-output model is greater than a threshold value from the forecast value generated by the regressor model at 1014.

If the forecast value generated by the multi-output model forecast value generated by the multi-output model is greater than a threshold value from the forecast value generated by the regressor model, the computing system can output the forecast value generated by the regressor model. In other words, the information (e.g., attribute values) received from the multi-output model was used to generate a more accurate forecast value at 1012.

If the forecast value generated by the multi-output model forecast value generated by the multi-output model is not greater than a threshold value from the forecast value generated by the regressor model, the computing system can output the forecast value generated by the regressor model. In other words, the information (e.g., attribute values) received from the multi-output model did not result in generation of a significantly different forecast value at 1016.

As noted above, infrastructure as a service (IaaS) is one particular type of cloud computing. IaaS can be configured to provide virtualized computing resources over a public network (e.g., the Internet). In an IaaS model, a cloud computing provider can host the infrastructure components (e.g., servers, storage devices, network nodes (e.g., hardware), deployment software, platform virtualization (e.g., a hypervisor layer), or the like). In some cases, an IaaS provider may also supply a variety of services to accompany those infrastructure components (example services include billing software, monitoring software, logging software, load balancing software, clustering software, etc.). Thus, as these services may be policy-driven, IaaS users may be able to implement policies to drive load balancing to maintain application availability and performance.

In some instances, IaaS customers may access resources and services through a wide area network (WAN), such as the Internet, and can use the cloud provider's services to install the remaining elements of an application stack. For example, the user can log in to the IaaS platform to create virtual machines (VMs), install operating systems (OSs) on each VM, deploy middleware such as databases, create storage buckets for workloads and backups, and even install enterprise software into that VM. Customers can then use the provider's services to perform various functions, including balancing network traffic, troubleshooting application issues, monitoring performance, managing disaster recovery, etc.

In most cases, a cloud computing model will require the participation of a cloud provider. The cloud provider may, but need not be, a third-party service that specializes in providing (e.g., offering, renting, selling) IaaS. An entity might also opt to deploy a private cloud, becoming its own provider of infrastructure services.

In some examples, IaaS deployment is the process of putting a new application, or a new version of an application, onto a prepared application server or the like. It may also include the process of preparing the server (e.g., installing libraries, daemons, etc.). This is often managed by the cloud provider, below the hypervisor layer (e.g., the servers, storage, network hardware, and virtualization). Thus, the customer may be responsible for handling (OS), middleware, and/or application deployment (e.g., on self-service virtual machines (e.g., that can be spun up on demand) or the like.

In some examples, IaaS provisioning may refer to acquiring computers or virtual hosts for use, and even installing needed libraries or services on them. In most cases, deployment does not include provisioning, and the provisioning may need to be performed first.

In some cases, there are two different challenges for IaaS provisioning. First, there is the initial challenge of provisioning the initial set of infrastructure before anything is running. Second, there is the challenge of evolving the existing infrastructure (e.g., adding new services, changing services, removing services, etc.) once everything has been provisioned. In some cases, these two challenges may be addressed by enabling the configuration of the infrastructure to be defined declaratively. In other words, the infrastructure (e.g., what components are needed and how they interact) can be defined by one or more configuration files. Thus, the overall topology of the infrastructure (e.g., what resources depend on which, and how they each work together) can be described declaratively. In some instances, once the topology is defined, a workflow can be generated that creates and/or manages the different components described in the configuration files.

In some examples, an infrastructure may have many interconnected elements. For example, there may be one or more virtual private clouds (VPCs) (e.g., a potentially on-demand pool of configurable and/or shared computing resources), also known as a core network. In some examples, there may also be one or more inbound/outbound traffic group rules provisioned to define how the inbound and/or outbound traffic of the network will be set up and one or more virtual machines (VMs). Other infrastructure elements may also be provisioned, such as a load balancer, a database, or the like. As more and more infrastructure elements are desired and/or added, the infrastructure may incrementally evolve.

In some instances, continuous deployment techniques may be employed to enable deployment of infrastructure code across various virtual computing environments. Additionally, the described techniques can enable infrastructure management within these environments. In some examples, service teams can write code that is desired to be deployed to one or more, but often many, different production environments (e.g., across various different geographic locations, sometimes spanning the entire world). However, in some examples, the infrastructure on which the code will be deployed must first be set up. In some instances, the provisioning can be done manually, a provisioning tool may be utilized to provision the resources, and/or deployment tools may be utilized to deploy the code once the infrastructure is provisioned.

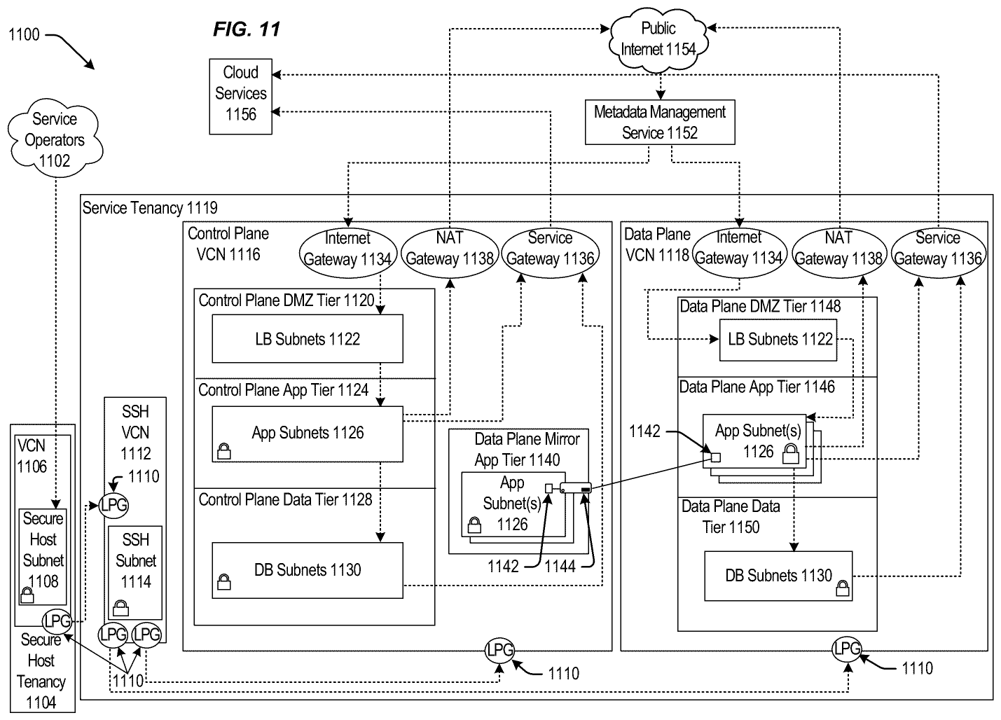

FIG. 11 is a block diagram 1100 illustrating an example pattern of an IaaS architecture, according to at least one embodiment. Service operators 1102 can be communicatively coupled to a secure host tenancy 1104 that can include a virtual cloud network (VCN) 1106 and a secure host subnet 1108. In some examples, the service operators 1102 may be using one or more client computing devices, which may be portable handheld devices (e.g., an iPhone®, cellular telephone, an iPad®, computing tablet, a personal digital assistant (PDA)) or wearable devices (e.g., a Google Glass® head mounted display), running software such as Microsoft Windows Mobile®, and/or a variety of mobile operating systems such as iOS, Windows Phone, Android, BlackBerry 8, Palm OS, and the like, and being Internet, e-mail, short message service (SMS), Blackberry®, or other communication protocol enabled. Alternatively, the client computing devices can be general purpose personal computers including, by way of example, personal computers and/or laptop computers running various versions of Microsoft Windows®, Apple Macintosh®, and/or Linux operating systems. The client computing devices can be workstation computers running any of a variety of commercially-available UNIX® or UNIX-like operating systems, including without limitation the variety of GNU/Linux operating systems, such as for example, Google Chrome OS. Alternatively, or in addition, client computing devices may be any other electronic device, such as a thin-client computer, an Internet-enabled gaming system (e.g., a Microsoft Xbox gaming console with or without a Kinect® gesture input device), and/or a personal messaging device, capable of communicating over a network that can access the VCN 1106 and/or the Internet.

The VCN 1106 can include a local peering gateway (LPG) 1110 that can be communicatively coupled to a secure shell (SSH) VCN 1112 via an LPG 1110 contained in the SSH VCN 1112. The SSH VCN 1112 can include an SSH subnet 1114, and the SSH VCN 1112 can be communicatively coupled to a control plane VCN 1116 via the LPG 1110 contained in the control plane VCN 1116. Also, the SSH VCN 1112 can be communicatively coupled to a data plane VCN 1118 via an LPG 1110. The control plane VCN 1116 and the data plane VCN 1118 can be contained in a service tenancy 1119 that can be owned and/or operated by the IaaS provider.

The control plane VCN 1116 can include a control plane demilitarized zone (DMZ) tier 1120 that acts as a perimeter network (e.g., portions of a corporate network between the corporate intranet and external networks). The DMZ-based servers may have restricted responsibilities and help keep breaches contained. Additionally, the DMZ tier 1120 can include one or more load balancer (LB) subnet(s) 1122, a control plane app tier 1124 that can include app subnet(s) 1126, a control plane data tier 1128 that can include database (DB) subnet(s) 1130 (e.g., frontend DB subnet(s) and/or backend DB subnet(s)). The LB subnet(s) 1122 contained in the control plane DMZ tier 1120 can be communicatively coupled to the app subnet(s) 1126 contained in the control plane app tier 1124 and an Internet gateway 1134 that can be contained in the control plane VCN 1116, and the app subnet(s) 1126 can be communicatively coupled to the DB subnet(s) 1130 contained in the control plane data tier 1128 and a service gateway 1136 and a network address translation (NAT) gateway 1138. The control plane VCN 1116 can include the service gateway 1136 and the NAT gateway 1138.

The control plane VCN 1116 can include a data plane mirror app tier 1140 that can include app subnet(s) 1126. The app subnet(s) 1126 contained in the data plane mirror app tier 1140 can include a virtual network interface controller (VNIC) 1142 that can execute a compute instance 1144. The compute instance 1144 can communicatively couple the app subnet(s) 1126 of the data plane mirror app tier 1140 to app subnet(s) 1126 that can be contained in a data plane app tier 1146.

The data plane VCN 1118 can include the data plane app tier 1146, a data plane DMZ tier 1148, and a data plane data tier 1150. The data plane DMZ tier 1148 can include LB subnet(s) 1122 that can be communicatively coupled to the app subnet(s) 1126 of the data plane app tier 1146 and the Internet gateway 1134 of the data plane VCN 1118. The app subnet(s) 1126 can be communicatively coupled to the service gateway 1136 of the data plane VCN 1118 and the NAT gateway 1138 of the data plane VCN 1118. The data plane data tier 1150 can also include the DB subnet(s) 1130 that can be communicatively coupled to the app subnet(s) 1126 of the data plane app tier 1146.

The Internet gateway 1134 of the control plane VCN 1116 and of the data plane VCN 1118 can be communicatively coupled to a metadata management service 1152 that can be communicatively coupled to public Internet 1154. Public Internet 1154 can be communicatively coupled to the NAT gateway 1138 of the control plane VCN 1116 and of the data plane VCN 1118. The service gateway 1136 of the control plane VCN 1116 and of the data plane VCN 1118 can be communicatively coupled to cloud services 1156.

In some examples, the service gateway 1136 of the control plane VCN 1116 or of the data plane VCN 1118 can make application programming interface (API) calls to cloud services 1156 without going through public Internet 1154. The API calls to cloud services 1156 from the service gateway 1136 can be one-way: the service gateway 1136 can make API calls to cloud services 1156, and cloud services 1156 can send requested data to the service gateway 1136. But, cloud services 1156 may not initiate API calls to the service gateway 1136.

In some examples, the secure host tenancy 1104 can be directly connected to the service tenancy 1119, which may be otherwise isolated. The secure host subnet 1108 can communicate with the SSH subnet 1114 through an LPG 1110 that may enable two-way communication over an otherwise isolated system. Connecting the secure host subnet 1108 to the SSH subnet 1114 may give the secure host subnet 1108 access to other entities within the service tenancy 1119.

The control plane VCN 1116 may allow users of the service tenancy 1119 to set up or otherwise provision desired resources. Desired resources provisioned in the control plane VCN 1116 may be deployed or otherwise used in the data plane VCN 1118. In some examples, the control plane VCN 1116 can be isolated from the data plane VCN 1118, and the data plane mirror app tier 1140 of the control plane VCN 1116 can communicate with the data plane app tier 1146 of the data plane VCN 1118 via VNICs 1142 that can be contained in the data plane mirror app tier 1140 and the data plane app tier 1146.

In some examples, users of the system, or customers, can make requests, for example create, read, update, or delete (CRUD) operations, through public Internet 1154 that can communicate the requests to the metadata management service 1152. The metadata management service 1152 can communicate the request to the control plane VCN 1116 through the Internet gateway 1134. The request can be received by the LB subnet(s) 1122 contained in the control plane DMZ tier 1120. The LB subnet(s) 1122 may determine that the request is valid, and in response to this determination, the LB subnet(s) 1122 can transmit the request to app subnet(s) 1126 contained in the control plane app tier 1124. If the request is validated and requires a call to public Internet 1154, the call to public Internet 1154 may be transmitted to the NAT gateway 1138 that can make the call to public Internet 1154. Metadata that may be desired to be stored by the request can be stored in the DB subnet(s) 1130.

In some examples, the data plane mirror app tier 1140 can facilitate direct communication between the control plane VCN 1116 and the data plane VCN 1118. For example, changes, updates, or other suitable modifications to configuration may be desired to be applied to the resources contained in the data plane VCN 1118. Via a VNIC 1142, the control plane VCN 1116 can directly communicate with, and can thereby execute the changes, updates, or other suitable modifications to configuration to, resources contained in the data plane VCN 1118.

In some embodiments, the control plane VCN 1116 and the data plane VCN 1118 can be contained in the service tenancy 1119. In this case, the user, or the customer, of the system may not own or operate either the control plane VCN 1116 or the data plane VCN 1118. Instead, the IaaS provider may own or operate the control plane VCN 1116 and the data plane VCN 1118, both of which may be contained in the service tenancy 1119. This embodiment can enable isolation of networks that may prevent users or customers from interacting with other users', or other customers', resources. Also, this embodiment may allow users or customers of the system to store databases privately without needing to rely on public Internet 1154, which may not have a desired level of threat prevention, for storage.

In other embodiments, the LB subnet(s) 1122 contained in the control plane VCN 1116 can be configured to receive a signal from the service gateway 1136. In this embodiment, the control plane VCN 1116 and the data plane VCN 1118 may be configured to be called by a customer of the IaaS provider without calling public Internet 1154. Customers of the IaaS provider may desire this embodiment since database(s) that the customers use may be controlled by the IaaS provider and may be stored on the service tenancy 1119, which may be isolated from public Internet 1154.

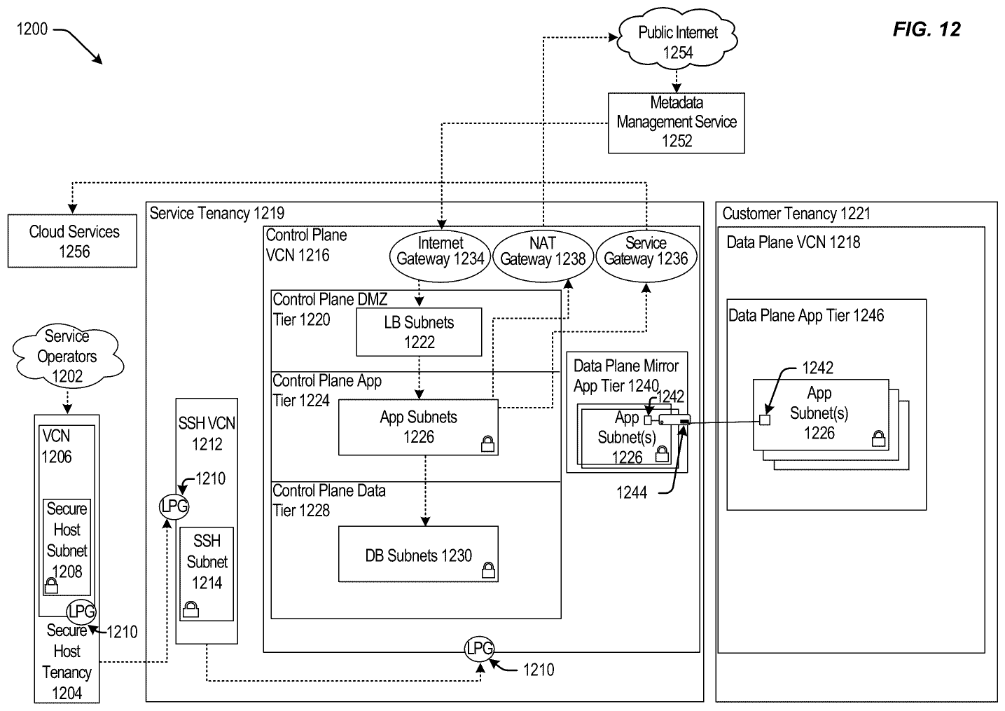

FIG. 12 is a block diagram 1200 illustrating another example pattern of an IaaS architecture, according to at least one embodiment. Service operators 1202 (e.g., service operators 1102 of FIG. 11) can be communicatively coupled to a secure host tenancy 1204 (e.g., the secure host tenancy 1104 of FIG. 11) that can include a virtual cloud network (VCN) 1206 (e.g., the VCN 1106 of FIG. 11) and a secure host subnet 1208 (e.g., the secure host subnet 1108 of FIG. 11). The VCN 1206 can include a local peering gateway (LPG) 1210 (e.g., the LPG 1110 of FIG. 11) that can be communicatively coupled to a secure shell (SSH) VCN 1212 (e.g., the SSH VCN 1112 of FIG. 11) via an LPG 1110 contained in the SSH VCN 1212. The SSH VCN 1212 can include an SSH subnet 1214 (e.g., the SSH subnet 1114 of FIG. 11), and the SSH VCN 1212 can be communicatively coupled to a control plane VCN 1216 (e.g., the control plane VCN 1116 of FIG. 11) via an LPG 1210 contained in the control plane VCN 1216. The control plane VCN 1216 can be contained in a service tenancy 1219 (e.g., the service tenancy 1119 of FIG. 11), and the data plane VCN 1218 (e.g., the data plane VCN 1118 of FIG. 11) can be contained in a customer tenancy 1221 that may be owned or operated by users, or customers, of the system.

The control plane VCN 1216 can include a control plane DMZ tier 1220 (e.g., the control plane DMZ tier 1120 of FIG. 11) that can include LB subnet(s) 1222 (e.g., LB subnet(s) 1122 of FIG. 11), a control plane app tier 1224 (e.g., the control plane app tier 1124 of FIG. 11) that can include app subnet(s) 1226 (e.g., app subnet(s) 1126 of FIG. 11), a control plane data tier 1228 (e.g., the control plane data tier 1128 of FIG. 11) that can include database (DB) subnet(s) 1230 (e.g., similar to DB subnet(s) 1130 of FIG. 11). The LB subnet(s) 1222 contained in the control plane DMZ tier 1220 can be communicatively coupled to the app subnet(s) 1226 contained in the control plane app tier 1224 and an Internet gateway 1234 (e.g., the Internet gateway 1134 of FIG. 11) that can be contained in the control plane VCN 1216, and the app subnet(s) 1226 can be communicatively coupled to the DB subnet(s) 1230 contained in the control plane data tier 1228 and a service gateway 1236 (e.g., the service gateway 1136 of FIG. 11) and a network address translation (NAT) gateway 1238 (e.g., the NAT gateway 1138 of FIG. 11). The control plane VCN 1216 can include the service gateway 1236 and the NAT gateway 1238.

The control plane VCN 1216 can include a data plane mirror app tier 1240 (e.g., the data plane mirror app tier 1140 of FIG. 11) that can include app subnet(s) 1226. The app subnet(s) 1226 contained in the data plane mirror app tier 1240 can include a virtual network interface controller (VNIC) 1242 (e.g., the VNIC of 1142) that can execute a compute instance 1244 (e.g., similar to the compute instance 1144 of FIG. 11). The compute instance 1244 can facilitate communication between the app subnet(s) 1226 of the data plane mirror app tier 1240 and the app subnet(s) 1226 that can be contained in a data plane app tier 1246 (e.g., the data plane app tier 1146 of FIG. 11) via the VNIC 1242 contained in the data plane mirror app tier 1240 and the VNIC 1242 contained in the data plane app tier 1246.

The Internet gateway 1234 contained in the control plane VCN 1216 can be communicatively coupled to a metadata management service 1252 (e.g., the metadata management service 1152 of FIG. 11) that can be communicatively coupled to public Internet 1254 (e.g., public Internet 1154 of FIG. 11). Public Internet 1254 can be communicatively coupled to the NAT gateway 1238 contained in the control plane VCN 1216. The service gateway 1236 contained in the control plane VCN 1216 can be communicatively couple to cloud services 1256 (e.g., cloud services 1156 of FIG. 11).

In some examples, the data plane VCN 1218 can be contained in the customer tenancy 1221. In this case, the IaaS provider may provide the control plane VCN 1216 for each customer, and the IaaS provider may, for each customer, set up a unique compute instance 1244 that is contained in the service tenancy 1219. Each compute instance 1244 may allow communication between the control plane VCN 1216, contained in the service tenancy 1219, and the data plane VCN 1218 that is contained in the customer tenancy 1221. The compute instance 1244 may allow resources, that are provisioned in the control plane VCN 1216 that is contained in the service tenancy 1219, to be deployed or otherwise used in the data plane VCN 1218 that is contained in the customer tenancy 1221.

In other examples, the customer of the IaaS provider may have databases that live in the customer tenancy 1221. In this example, the control plane VCN 1216 can include the data plane mirror app tier 1240 that can include app subnet(s) 1226. The data plane mirror app tier 1240 can reside in the data plane VCN 1218, but the data plane mirror app tier 1240 may not live in the data plane VCN 1218. That is, the data plane mirror app tier 1240 may have access to the customer tenancy 1221, but the data plane mirror app tier 1240 may not exist in the data plane VCN 1218 or be owned or operated by the customer of the IaaS provider. The data plane mirror app tier 1240 may be configured to make calls to the data plane VCN 1218 but may not be configured to make calls to any entity contained in the control plane VCN 1216. The customer may desire to deploy or otherwise use resources in the data plane VCN 1218 that are provisioned in the control plane VCN 1216, and the data plane mirror app tier 1240 can facilitate the desired deployment, or other usage of resources, of the customer.

In some embodiments, the customer of the IaaS provider can apply filters to the data plane VCN 1218. In this embodiment, the customer can determine what the data plane VCN 1218 can access, and the customer may restrict access to public Internet 1254 from the data plane VCN 1218. The IaaS provider may not be able to apply filters or otherwise control access of the data plane VCN 1218 to any outside networks or databases. Applying filters and controls by the customer onto the data plane VCN 1218, contained in the customer tenancy 1221, can help isolate the data plane VCN 1218 from other customers and from public Internet 1254.

In some embodiments, cloud services 1256 can be called by the service gateway 1236 to access services that may not exist on public Internet 1254, on the control plane VCN 1216, or on the data plane VCN 1218. The connection between cloud services 1256 and the control plane VCN 1216 or the data plane VCN 1218 may not be live or continuous. Cloud services 1256 may exist on a different network owned or operated by the IaaS provider. Cloud services 1256 may be configured to receive calls from the service gateway 1236 and may be configured to not receive calls from public Internet 1254. Some cloud services 1256 may be isolated from other cloud services 1256, and the control plane VCN 1216 may be isolated from cloud services 1256 that may not be in the same region as the control plane VCN 1216. For example, the control plane VCN 1216 may be located in “Region 1,” and cloud service “Deployment 11,” may be located in Region 1 and in “Region 2.” If a call to Deployment 11 is made by the service gateway 1236 contained in the control plane VCN 1216 located in Region 1, the call may be transmitted to Deployment 11 in Region 1. In this example, the control plane VCN 1216, or Deployment 11 in Region 1, may not be communicatively coupled to, or otherwise in communication with, Deployment 11 in Region 2.

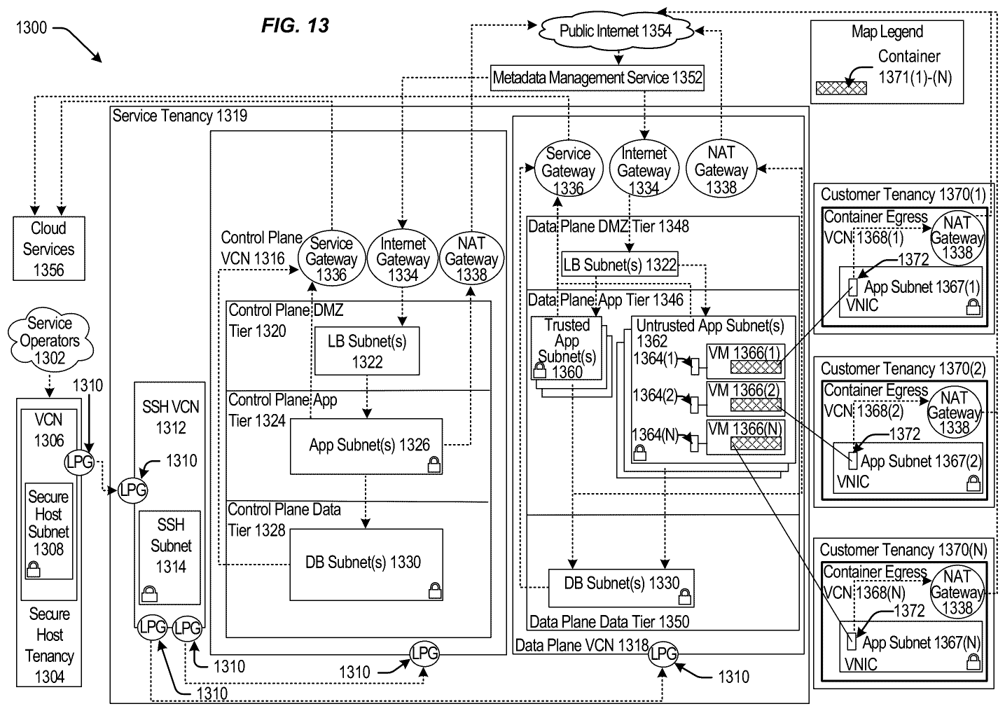

FIG. 13 is a block diagram 1300 illustrating another example pattern of an IaaS architecture, according to at least one embodiment. Service operators 1302 (e.g., service operators 1102 of FIG. 11) can be communicatively coupled to a secure host tenancy 1304 (e.g., the secure host tenancy 1104 of FIG. 11) that can include a virtual cloud network (VCN) 1306 (e.g., the VCN 1106 of FIG. 11) and a secure host subnet 1308 (e.g., the secure host subnet 1108 of FIG. 11). The VCN 1306 can include an LPG 1310 (e.g., the LPG 1110 of FIG. 11) that can be communicatively coupled to an SSH VCN 1312 (e.g., the SSH VCN 1112 of FIG. 11) via an LPG 1310 contained in the SSH VCN 1312. The SSH VCN 1312 can include an SSH subnet 1314 (e.g., the SSH subnet 1114 of FIG. 11), and the SSH VCN 1312 can be communicatively coupled to a control plane VCN 1316 (e.g., the control plane VCN 1116 of FIG. 11) via an LPG 1310 contained in the control plane VCN 1316 and to a data plane VCN 1318 (e.g., the data plane 1118 of FIG. 11) via an LPG 1310 contained in the data plane VCN 1318. The control plane VCN 1316 and the data plane VCN 1318 can be contained in a service tenancy 1319 (e.g., the service tenancy 1119 of FIG. 11).

The control plane VCN 1316 can include a control plane DMZ tier 1320 (e.g., the control plane DMZ tier 1120 of FIG. 11) that can include load balancer (LB) subnet(s) 1322 (e.g., LB subnet(s) 1122 of FIG. 11), a control plane app tier 1324 (e.g., the control plane app tier 1124 of FIG. 11) that can include app subnet(s) 1326 (e.g., similar to app subnet(s) 1126 of FIG. 11), a control plane data tier 1328 (e.g., the control plane data tier 1128 of FIG. 11) that can include DB subnet(s) 1330. The LB subnet(s) 1322 contained in the control plane DMZ tier 1320 can be communicatively coupled to the app subnet(s) 1326 contained in the control plane app tier 1324 and to an Internet gateway 1334 (e.g., the Internet gateway 1134 of FIG. 11) that can be contained in the control plane VCN 1316, and the app subnet(s) 1326 can be communicatively coupled to the DB subnet(s) 1330 contained in the control plane data tier 1328 and to a service gateway 1336 (e.g., the service gateway of FIG. 11) and a network address translation (NAT) gateway 1338 (e.g., the NAT gateway 1138 of FIG. 11). The control plane VCN 1316 can include the service gateway 1336 and the NAT gateway 1338.

The data plane VCN 1318 can include a data plane app tier 1346 (e.g., the data plane app tier 1146 of FIG. 11), a data plane DMZ tier 1348 (e.g., the data plane DMZ tier 1148 of FIG. 11), and a data plane data tier 1350 (e.g., the data plane data tier 1150 of FIG. 11). The data plane DMZ tier 1348 can include LB subnet(s) 1322 that can be communicatively coupled to trusted app subnet(s) 1360 and untrusted app subnet(s) 1362 of the data plane app tier 1346 and the Internet gateway 1334 contained in the data plane VCN 1318. The trusted app subnet(s) 1360 can be communicatively coupled to the service gateway 1336 contained in the data plane VCN 1318, the NAT gateway 1338 contained in the data plane VCN 1318, and DB subnet(s) 1330 contained in the data plane data tier 1350. The untrusted app subnet(s) 1362 can be communicatively coupled to the service gateway 1336 contained in the data plane VCN 1318 and DB subnet(s) 1330 contained in the data plane data tier 1350. The data plane data tier 1350 can include DB subnet(s) 1330 that can be communicatively coupled to the service gateway 1336 contained in the data plane VCN 1318.

The untrusted app subnet(s) 1362 can include one or more primary VNICs 1364(1)-(N) that can be communicatively coupled to tenant virtual machines (VMs) 1366(1)-(N). Each tenant VM 1366(1)-(N) can be communicatively coupled to a respective app subnet 1367(1)-(N) that can be contained in respective container egress VCNs 1368(1)-(N) that can be contained in respective customer tenancies 1370(1)-(N). Respective secondary VNICs 1372(1)-(N) can facilitate communication between the untrusted app subnet(s) 1362 contained in the data plane VCN 1318 and the app subnet contained in the container egress VCNs 1368(1)-(N). Each container egress VCNs 1368(1)-(N) can include a NAT gateway 1338 that can be communicatively coupled to public Internet 1354 (e.g., public Internet 1154 of FIG. 11).

The Internet gateway 1334 contained in the control plane VCN 1316 and contained in the data plane VCN 1318 can be communicatively coupled to a metadata management service 1352 (e.g., the metadata management system 1152 of FIG. 11) that can be communicatively coupled to public Internet 1354. Public Internet 1354 can be communicatively coupled to the NAT gateway 1338 contained in the control plane VCN 1316 and contained in the data plane VCN 1318. The service gateway 1336 contained in the control plane VCN 1316 and contained in the data plane VCN 1318 can be communicatively coupled to cloud services 1356.

In some embodiments, the data plane VCN 1318 can be integrated with customer tenancies 1370. This integration can be useful or desirable for customers of the IaaS provider in some cases such as a case that may desire support when executing code. The customer may provide code to run that may be destructive, may communicate with other customer resources, or may otherwise cause undesirable effects. In response to this, the IaaS provider may determine whether to run code given to the IaaS provider by the customer.

In some examples, the customer of the IaaS provider may grant temporary network access to the IaaS provider and request a function to be attached to the data plane app tier 1346. Code to run the function may be executed in the VMs 1366(1)-(N), and the code may not be configured to run anywhere else on the data plane VCN 1318. Each VM 1366(1)-(N) may be connected to one customer tenancy 1370. Respective containers 1371(1)-(N) contained in the VMs 1366(1)-(N) may be configured to run the code. In this case, there can be a dual isolation (e.g., the containers 1371(1)-(N) running code, where the containers 1371(1)-(N) may be contained in at least the VM 1366(1)-(N) that are contained in the untrusted app subnet(s) 1362), which may help prevent incorrect or otherwise undesirable code from damaging the network of the IaaS provider or from damaging a network of a different customer. The containers 1371(1)-(N) may be communicatively coupled to the customer tenancy 1370 and may be configured to transmit or receive data from the customer tenancy 1370. The containers 1371(1)-(N) may not be configured to transmit or receive data from any other entity in the data plane VCN 1318. Upon completion of running the code, the IaaS provider may kill or otherwise dispose of the containers 1371(1)-(N).

In some embodiments, the trusted app subnet(s) 1360 may run code that may be owned or operated by the IaaS provider. In this embodiment, the trusted app subnet(s) 1360 may be communicatively coupled to the DB subnet(s) 1330 and be configured to execute CRUD operations in the DB subnet(s) 1330. The untrusted app subnet(s) 1362 may be communicatively coupled to the DB subnet(s) 1330, but in this embodiment, the untrusted app subnet(s) may be configured to execute read operations in the DB subnet(s) 1330. The containers 1371(1)-(N) that can be contained in the VM 1366(1)-(N) of each customer and that may run code from the customer may not be communicatively coupled with the DB subnet(s) 1330.

In other embodiments, the control plane VCN 1316 and the data plane VCN 1318 may not be directly communicatively coupled. In this embodiment, there may be no direct communication between the control plane VCN 1316 and the data plane VCN 1318. However, communication can occur indirectly through at least one method. An LPG 1310 may be established by the IaaS provider that can facilitate communication between the control plane VCN 1316 and the data plane VCN 1318. In another example, the control plane VCN 1316 or the data plane VCN 1318 can make a call to cloud services 1356 via the service gateway 1336. For example, a call to cloud services 1356 from the control plane VCN 1316 can include a request for a service that can communicate with the data plane VCN 1318.

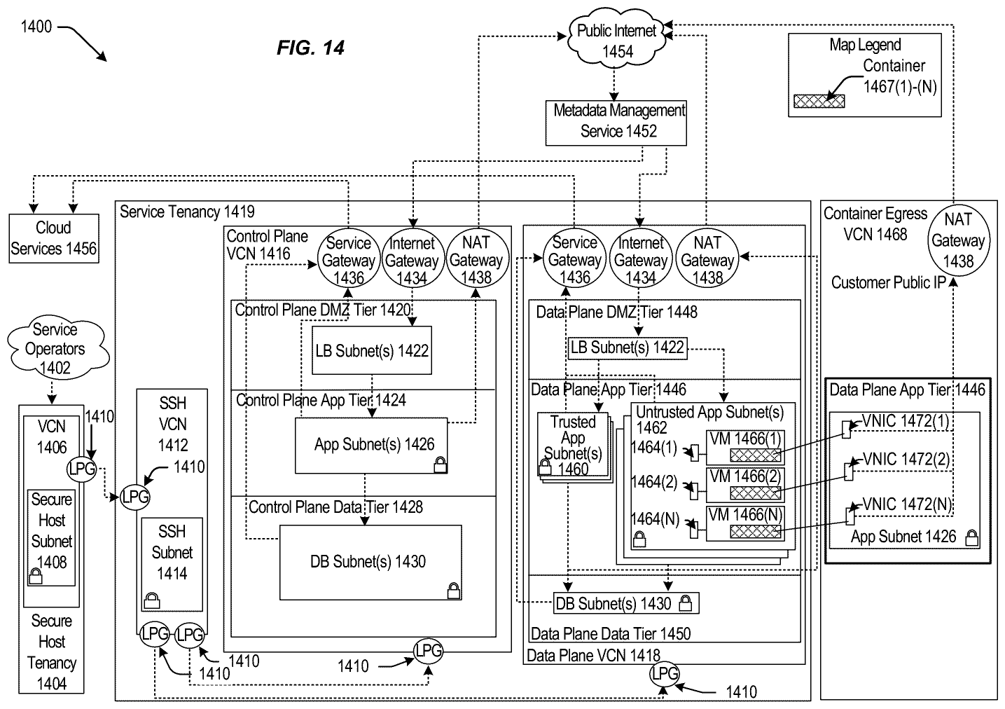

FIG. 14 is a block diagram 1400 illustrating another example pattern of an IaaS architecture, according to at least one embodiment. Service operators 1402 (e.g., service operators 1102 of FIG. 11) can be communicatively coupled to a secure host tenancy 1404 (e.g., the secure host tenancy 1104 of FIG. 11) that can include a virtual cloud network (VCN) 1406 (e.g., the VCN 1106 of FIG. 11) and a secure host subnet 1408 (e.g., the secure host subnet 1108 of FIG. 11). The VCN 1406 can include an LPG 1410 (e.g., the LPG 1110 of FIG. 11) that can be communicatively coupled to an SSH VCN 1412 (e.g., the SSH VCN 1112 of FIG. 11) via an LPG 1410 contained in the SSH VCN 1412. The SSH VCN 1412 can include an SSH subnet 1414 (e.g., the SSH subnet 1114 of FIG. 11), and the SSH VCN 1412 can be communicatively coupled to a control plane VCN 1416 (e.g., the control plane VCN 1116 of FIG. 11) via an LPG 1410 contained in the control plane VCN 1416 and to a data plane VCN 1418 (e.g., the data plane 1118 of FIG. 11) via an LPG 1410 contained in the data plane VCN 1418. The control plane VCN 1416 and the data plane VCN 1418 can be contained in a service tenancy 1419 (e.g., the service tenancy 1119 of FIG. 11).

The control plane VCN 1416 can include a control plane DMZ tier 1420 (e.g., the control plane DMZ tier 1120 of FIG. 11) that can include LB subnet(s) 1422 (e.g., LB subnet(s) 1122 of FIG. 11), a control plane app tier 1424 (e.g., the control plane app tier 1124 of FIG. 11) that can include app subnet(s) 1426 (e.g., app subnet(s) 1126 of FIG. 11), a control plane data tier 1428 (e.g., the control plane data tier 1128 of FIG. 11) that can include DB subnet(s) 1430 (e.g., DB subnet(s) 1330 of FIG. 13). The LB subnet(s) 1422 contained in the control plane DMZ tier 1420 can be communicatively coupled to the app subnet(s) 1426 contained in the control plane app tier 1424 and to an Internet gateway 1434 (e.g., the Internet gateway 1134 of FIG. 11) that can be contained in the control plane VCN 1416, and the app subnet(s) 1426 can be communicatively coupled to the DB subnet(s) 1430 contained in the control plane data tier 1428 and to a service gateway 1436 (e.g., the service gateway of FIG. 11) and a network address translation (NAT) gateway 1438 (e.g., the NAT gateway 1138 of FIG. 11). The control plane VCN 1416 can include the service gateway 1436 and the NAT gateway 1438.

The data plane VCN 1418 can include a data plane app tier 1446 (e.g., the data plane app tier 1146 of FIG. 11), a data plane DMZ tier 1448 (e.g., the data plane DMZ tier 1148 of FIG. 11), and a data plane data tier 1450 (e.g., the data plane data tier 1150 of FIG. 11). The data plane DMZ tier 1448 can include LB subnet(s) 1422 that can be communicatively coupled to trusted app subnet(s) 1460 (e.g., trusted app subnet(s) 1360 of FIG. 13) and untrusted app subnet(s) 1462 (e.g., untrusted app subnet(s) 1362 of FIG. 13) of the data plane app tier 1446 and the Internet gateway 1434 contained in the data plane VCN 1418. The trusted app subnet(s) 1460 can be communicatively coupled to the service gateway 1436 contained in the data plane VCN 1418, the NAT gateway 1438 contained in the data plane VCN 1418, and DB subnet(s) 1430 contained in the data plane data tier 1450. The untrusted app subnet(s) 1462 can be communicatively coupled to the service gateway 1436 contained in the data plane VCN 1418 and DB subnet(s) 1430 contained in the data plane data tier 1450. The data plane data tier 1450 can include DB subnet(s) 1430 that can be communicatively coupled to the service gateway 1436 contained in the data plane VCN 1418.

The untrusted app subnet(s) 1462 can include primary VNICs 1464(1)-(N) that can be communicatively coupled to tenant virtual machines (VMs) 1466(1)-(N) residing within the untrusted app subnet(s) 1462. Each tenant VM 1466(1)-(N) can run code in a respective container 1467(1)-(N), and be communicatively coupled to an app subnet 1426 that can be contained in a data plane app tier 1446 that can be contained in a container egress VCN 1468. Respective secondary VNICs 1472(1)-(N) can facilitate communication between the untrusted app subnet(s) 1462 contained in the data plane VCN 1418 and the app subnet contained in the container egress VCN 1468. The container egress VCN can include a NAT gateway 1438 that can be communicatively coupled to public Internet 1454 (e.g., public Internet 1154 of FIG. 11).

The Internet gateway 1434 contained in the control plane VCN 1416 and contained in the data plane VCN 1418 can be communicatively coupled to a metadata management service 1452 (e.g., the metadata management system 1152 of FIG. 11) that can be communicatively coupled to public Internet 1454. Public Internet 1454 can be communicatively coupled to the NAT gateway 1438 contained in the control plane VCN 1416 and contained in the data plane VCN 1418. The service gateway 1436 contained in the control plane VCN 1416 and contained in the data plane VCN 1418 can be communicatively coupled to cloud services 1456.

In some examples, the pattern illustrated by the architecture of block diagram 1400 of FIG. 14 may be considered an exception to the pattern illustrated by the architecture of block diagram 1300 of FIG. 13 and may be desirable for a customer of the IaaS provider if the IaaS provider cannot directly communicate with the customer (e.g., a disconnected region). The respective containers 1467(1)-(N) that are contained in the VMs 1466(1)-(N) for each customer can be accessed in real-time by the customer. The containers 1467(1)-(N) may be configured to make calls to respective secondary VNICs 1472(1)-(N) contained in app subnet(s) 1426 of the data plane app tier 1446 that can be contained in the container egress VCN 1468. The secondary VNICs 1472(1)-(N) can transmit the calls to the NAT gateway 1438 that may transmit the calls to public Internet 1454. In this example, the containers 1467(1)-(N) that can be accessed in real-time by the customer can be isolated from the control plane VCN 1416 and can be isolated from other entities contained in the data plane VCN 1418. The containers 1467(1)-(N) may also be isolated from resources from other customers.

In other examples, the customer can use the containers 1467(1)-(N) to call cloud services 1456. In this example, the customer may run code in the containers 1467(1)-(N) that requests a service from cloud services 1456. The containers 1467(1)-(N) can transmit this request to the secondary VNICs 1472(1)-(N) that can transmit the request to the NAT gateway that can transmit the request to public Internet 1454. Public Internet 1454 can transmit the request to LB subnet(s) 1422 contained in the control plane VCN 1416 via the Internet gateway 1434. In response to determining the request is valid, the LB subnet(s) can transmit the request to app subnet(s) 1426 that can transmit the request to cloud services 1456 via the service gateway 1436.

It should be appreciated that IaaS architectures 1100, 1200, 1300, 1400 depicted in the figures may have other components than those depicted. Further, the embodiments shown in the figures are only some examples of a cloud infrastructure system that may incorporate an embodiment of the disclosure. In some other embodiments, the IaaS systems may have more or fewer components than shown in the figures, may combine two or more components, or may have a different configuration or arrangement of components.

In certain embodiments, the IaaS systems described herein may include a suite of applications, middleware, and database service offerings that are delivered to a customer in a self-service, subscription-based, elastically scalable, reliable, highly available, and secure manner. An example of such an IaaS system is the Oracle Cloud Infrastructure (OCI) provided by the present assignee.

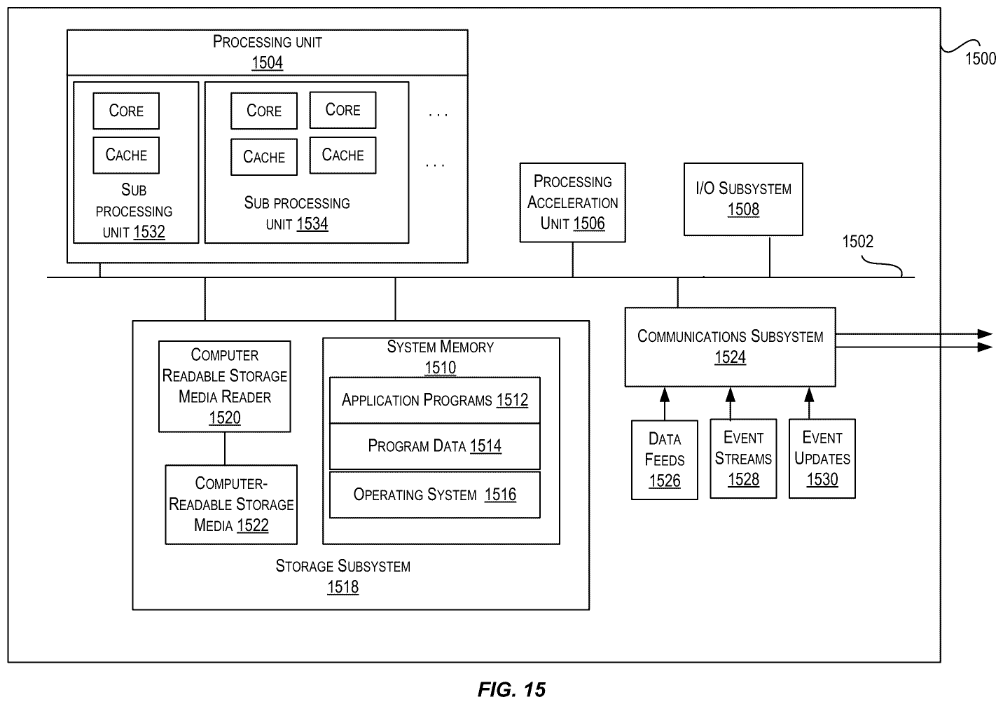

FIG. 15 illustrates an example computer system 1500, in which various embodiments may be implemented. The system 1500 may be used to implement any of the computer systems described above. As shown in the figure, computer system 1500 includes a processing unit 1504 that communicates with a number of peripheral subsystems via a bus subsystem 1502. These peripheral subsystems may include a processing acceleration unit 1506, an I/O subsystem 1508, a storage subsystem 1518 and a communications subsystem 1524. Storage subsystem 1518 includes tangible computer-readable storage media 1522 and a system memory 1510.

Bus subsystem 1502 provides a mechanism for letting the various components and subsystems of computer system 1500 communicate with each other as intended. Although bus subsystem 1502 is shown schematically as a single bus, alternative embodiments of the bus subsystem may utilize multiple buses. Bus subsystem 1502 may be any of several types of bus structures including a memory bus or memory controller, a peripheral bus, and a local bus using any of a variety of bus architectures. For example, such architectures may include an Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus, which can be implemented as a Mezzanine bus manufactured to the IEEE P1386.1 standard.

Processing unit 1504, which can be implemented as one or more integrated circuits (e.g., a conventional microprocessor or microcontroller), controls the operation of computer system 1500. One or more processors may be included in processing unit 1504. These processors may include single core or multicore processors. In certain embodiments, processing unit 1504 may be implemented as one or more independent processing units 1532 and/or 1534 with single or multicore processors included in each processing unit. In other embodiments, processing unit 1504 may also be implemented as a quad-core processing unit formed by integrating two dual-core processors into a single chip.

In various embodiments, processing unit 1504 can execute a variety of programs in response to program code and can maintain multiple concurrently executing programs or processes. At any given time, some or all of the program code to be executed can be resident in processor(s) 1504 and/or in storage subsystem 1518. Through suitable programming, processor(s) 1504 can provide various functionalities described above. Computer system 1500 may additionally include a processing acceleration unit 1506, which can include a digital signal processor (DSP), a special-purpose processor, and/or the like.

I/O subsystem 1508 may include user interface input devices and user interface output devices. User interface input devices may include a keyboard, pointing devices such as a mouse or trackball, a touchpad or touch screen incorporated into a display, a scroll wheel, a click wheel, a dial, a button, a switch, a keypad, audio input devices with voice command recognition systems, microphones, and other types of input devices. User interface input devices may include, for example, motion sensing and/or gesture recognition devices such as the Microsoft Kinect® motion sensor that enables users to control and interact with an input device, such as the Microsoft Xbox® 360 game controller, through a natural user interface using gestures and spoken commands. User interface input devices may also include eye gesture recognition devices such as the Google Glass® blink detector that detects eye activity (e.g., ‘blinking’ while taking pictures and/or making a menu selection) from users and transforms the eye gestures as input into an input device (e.g., Google Glass®). Additionally, user interface input devices may include voice recognition sensing devices that enable users to interact with voice recognition systems (e.g., Siri® navigator), through voice commands.

User interface input devices may also include, without limitation, three dimensional (3D) mice, joysticks or pointing sticks, gamepads and graphic tablets, and audio/visual devices such as speakers, digital cameras, digital camcorders, portable media players, webcams, image scanners, fingerprint scanners, barcode reader 3D scanners, 3D printers, laser rangefinders, and eye gaze tracking devices. Additionally, user interface input devices may include, for example, medical imaging input devices such as computed tomography, magnetic resonance imaging, position emission tomography, medical ultrasonography devices. User interface input devices may also include, for example, audio input devices such as MIDI keyboards, digital musical instruments and the like.

User interface output devices may include a display subsystem, indicator lights, or non-visual displays such as audio output devices, etc. The display subsystem may be a cathode ray tube (CRT), a flat-panel device, such as that using a liquid crystal display (LCD) or plasma display, a projection device, a touch screen, and the like. In general, use of the term “output device” is intended to include all possible types of devices and mechanisms for outputting information from computer system 1500 to a user or other computer. For example, user interface output devices may include, without limitation, a variety of display devices that visually convey text, graphics and audio/video information such as monitors, printers, speakers, headphones, automotive navigation systems, plotters, voice output devices, and modems.

Computer system 1500 may comprise a storage subsystem 1518 that comprises software elements, shown as being currently located within a system memory 1510. System memory 1510 may store program instructions that are loadable and executable on processing unit 1504, as well as data generated during the execution of these programs.

Depending on the configuration and type of computer system 1500, system memory 1510 may be volatile (such as random access memory (RAM)) and/or non-volatile (such as read-only memory (ROM), flash memory, etc.) The RAM typically contains data and/or program services that are immediately accessible to and/or presently being operated and executed by processing unit 1504. In some implementations, system memory 1510 may include multiple different types of memory, such as static random access memory (SRAM) or dynamic random access memory (DRAM). In some implementations, a basic input/output system (BIOS), containing the basic routines that help to transfer information between elements within computer system 1500, such as during start-up, may typically be stored in the ROM. By way of example, and not limitation, system memory 1510 also illustrates application programs 1512, which may include client applications, Web browsers, mid-tier applications, relational database management systems (RDBMS), etc., program data 1514, and an operating system 1516. By way of example, operating system 1516 may include various versions of Microsoft Windows®, Apple Macintosh®, and/or Linux operating systems, a variety of commercially-available UNIX® or UNIX-like operating systems (including without limitation the variety of GNU/Linux operating systems, the Google Chrome® OS, and the like) and/or mobile operating systems such as iOS, Windows® Phone, Android® OS, BlackBerry® OS, and Palm® OS operating systems.

Storage subsystem 1518 may also provide a tangible computer-readable storage medium for storing the basic programming and data constructs that provide the functionality of some embodiments. Software (programs, code services, instructions) that when executed by a processor provide the functionality described above may be stored in storage subsystem 1518. These software services or instructions may be executed by processing unit 1504. Storage subsystem 1518 may also provide a repository for storing data used in accordance with the present disclosure.

Storage subsystem 1500 may also include a computer-readable storage media reader 1520 that can further be connected to computer-readable storage media 1522. Together and, optionally, in combination with system memory 1510, computer-readable storage media 1522 may comprehensively represent remote, local, fixed, and/or removable storage devices plus storage media for temporarily and/or more permanently containing, storing, transmitting, and retrieving computer-readable information.

Computer-readable storage media 1522 containing code, or portions of code, can also include any appropriate media known or used in the art, including storage media and communication media, such as but not limited to, volatile and non-volatile, removable and non-removable media implemented in any method or technology for storage and/or transmission of information. This can include tangible computer-readable storage media such as RAM, ROM, electronically erasable programmable ROM (EEPROM), flash memory or other memory technology, CD-ROM, digital versatile disk (DVD), or other optical storage, magnetic cassettes, magnetic tape, magnetic disk storage or other magnetic storage devices, or other tangible computer readable media. This can also include nontangible computer-readable media, such as data signals, data transmissions, or any other medium which can be used to transmit the desired information and which can be accessed by computing system 1500.

By way of example, computer-readable storage media 1522 may include a hard disk drive that reads from or writes to non-removable, nonvolatile magnetic media, a magnetic disk drive that reads from or writes to a removable, nonvolatile magnetic disk, and an optical disk drive that reads from or writes to a removable, nonvolatile optical disk such as a CD ROM, DVD, and Blu-Ray® disk, or other optical media. Computer-readable storage media 1522 may include, but is not limited to, Zip® drives, flash memory cards, universal serial bus (USB) flash drives, secure digital (SD) cards, DVD disks, digital video tape, and the like. Computer-readable storage media 1522 may also include, solid-state drives (SSD) based on non-volatile memory such as flash-memory based SSDs, enterprise flash drives, solid state ROM, and the like, SSDs based on volatile memory such as solid state RAM, dynamic RAM, static RAM, DRAM-based SSDs, magnetoresistive RAM (MRAM) SSDs, and hybrid SSDs that use a combination of DRAM and flash memory based SSDs. The disk drives and their associated computer-readable media may provide non-volatile storage of computer-readable instructions, data structures, program services, and other data for computer system 1500.

Communications subsystem 1524 provides an interface to other computer systems and networks. Communications subsystem 1524 serves as an interface for receiving data from and transmitting data to other systems from computer system 1500. For example, communications subsystem 1524 may enable computer system 1500 to connect to one or more devices via the Internet. In some embodiments communications subsystem 1524 can include radio frequency (RF) transceiver components for accessing wireless voice and/or data networks (e.g., using cellular telephone technology, advanced data network technology, such as 3G, 4G or EDGE (enhanced data rates for global evolution), WiFi (IEEE 802.11 family standards, or other mobile communication technologies, or any combination thereof), global positioning system (GPS) receiver components, and/or other components. In some embodiments communications subsystem 1524 can provide wired network connectivity (e.g., Ethernet) in addition to or instead of a wireless interface.

In some embodiments, communications subsystem 1524 may also receive input communication in the form of structured and/or unstructured data feeds 1526, event streams 1528, event updates 1530, and the like on behalf of one or more users who may use computer system 1500.

By way of example, communications subsystem 1524 may be configured to receive data feeds 1526 in real-time from users of social networks and/or other communication services such as Twitter® feeds, Facebook® updates, web feeds such as Rich Site Summary (RSS) feeds, and/or real-time updates from one or more third party information sources.

Additionally, communications subsystem 1524 may also be configured to receive data in the form of continuous data streams, which may include event streams 1528 of real-time events and/or event updates 1530, that may be continuous or unbounded in nature with no explicit end. Examples of applications that generate continuous data may include, for example, sensor data applications, financial tickers, network performance measuring tools (e.g., network monitoring and traffic management applications), clickstream analysis tools, automobile traffic monitoring, and the like.

Communications subsystem 1524 may also be configured to output the structured and/or unstructured data feeds 1526, event streams 1528, event updates 1530, and the like to one or more databases that may be in communication with one or more streaming data source computers coupled to computer system 1500.

Computer system 1500 can be one of various types, including a handheld portable device (e.g., an iPhone® cellular phone, an iPad® computing tablet, a PDA), a wearable device (e.g., a Google Glass® head mounted display), a PC, a workstation, a mainframe, a kiosk, a server rack, or any other data processing system.

Due to the ever-changing nature of computers and networks, the description of computer system 1500 depicted in the figure is intended only as a specific example. Many other configurations having more or fewer components than the system depicted in the figure are possible. For example, customized hardware might also be used and/or particular elements might be implemented in hardware, firmware, software (including applets), or a combination. Further, connection to other computing devices, such as network input/output devices, may be employed. Based on the disclosure and teachings provided herein, a person of ordinary skill in the art will appreciate other ways and/or methods to implement the various embodiments.

Although specific embodiments have been described, various modifications, alterations, alternative constructions, and equivalents are also encompassed within the scope of the disclosure. Embodiments are not restricted to operation within certain specific data processing environments, but are free to operate within a plurality of data processing environments. Additionally, although embodiments have been described using a particular series of transactions and steps, it should be apparent to those skilled in the art that the scope of the present disclosure is not limited to the described series of transactions and steps. Various features and aspects of the above-described embodiments may be used individually or jointly.

Further, while embodiments have been described using a particular combination of hardware and software, it should be recognized that other combinations of hardware and software are also within the scope of the present disclosure. Embodiments may be implemented only in hardware, or only in software, or using combinations thereof. The various processes described herein can be implemented on the same processor or different processors in any combination. Accordingly, where components or services are described as being configured to perform certain operations, such configuration can be accomplished, e.g., by designing electronic circuits to perform the operation, by programming programmable electronic circuits (such as microprocessors) to perform the operation, or any combination thereof. Processes can communicate using a variety of techniques including but not limited to conventional techniques for inter process communication, and different pairs of processes may use different techniques, or the same pair of processes may use different techniques at different times.

The specification and drawings are, accordingly, to be regarded in an illustrative rather than a restrictive sense. It will, however, be evident that additions, subtractions, deletions, and other modifications and changes may be made thereunto without departing from the broader spirit and scope as set forth in the claims. Thus, although specific disclosure embodiments have been described, these are not intended to be limiting. Various modifications and equivalents are within the scope of the following claims.

The use of the terms “a” and “an” and “the” and similar referents in the context of describing the disclosed embodiments (especially in the context of the following claims) are to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. The term “connected” is to be construed as partly or wholly contained within, attached to, or joined together, even if there is something intervening. Recitation of ranges of values herein are merely intended to serve as a shorthand method of referring individually to each separate value falling within the range, unless otherwise indicated herein and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate embodiments and does not pose a limitation on the scope of the disclosure unless otherwise claimed. No language in the specification should be construed as indicating any non-claimed element as essential to the practice of the disclosure.

Disjunctive language such as the phrase “at least one of X, Y, or Z,” unless specifically stated otherwise, is intended to be understood within the context as used in general to present that an item, term, etc., may be either X, Y, or Z, or any combination thereof (e.g., X, Y, and/or Z). Thus, such disjunctive language is not generally intended to, and should not, imply that certain embodiments require at least one of X, at least one of Y, or at least one of Z to each be present.

Preferred embodiments of this disclosure are described herein, including the best mode known for carrying out the disclosure. Variations of those preferred embodiments may become apparent to those of ordinary skill in the art upon reading the foregoing description. Those of ordinary skill should be able to employ such variations as appropriate and the disclosure may be practiced otherwise than as specifically described herein. Accordingly, this disclosure includes all modifications and equivalents of the subject matter recited in the claims appended hereto as permitted by applicable law. Moreover, any combination of the above-described elements in all possible variations thereof is encompassed by the disclosure unless otherwise indicated herein.

All references, including publications, patent applications, and patents, cited herein are hereby incorporated by reference to the same extent as if each reference were individually and specifically indicated to be incorporated by reference and were set forth in its entirety herein.

In the foregoing specification, aspects of the disclosure are described with reference to specific embodiments thereof, but those skilled in the art will recognize that the disclosure is not limited thereto. Various features and aspects of the above-described disclosure may be used individually or jointly. Further, embodiments can be utilized in any number of environments and applications beyond those described herein without departing from the broader spirit and scope of the specification. The specification and drawings are, accordingly, to be regarded as illustrative rather than restrictive.

What is claimed is:

1. A method, comprising:
receiving, by a computing system, a request to predict a value for a variable at a future time point based upon a time series, the time series comprising a sequence of data points, each data point in the sequence of data points identifying a time point and at least one value associated with the time point; and
predicting, by the computing system and using a first trained machine learning model and based upon the times series, a plurality of forecast values for the future time point, the plurality of forecast values including:
a first forecast value predicted for the variable at the future time point; and
a set of one or more forecast attribute values for one or more attributes of the time series, each of the set of one or more forecast attribute values predicted for the future time point.

2. The method of claim 1, wherein the method further comprises:
providing the plurality of forecast values as input to a second trained machine learning model; and
predicting, using the second trained machine learning model and based upon the plurality of forecast values provided as input to the second trained machine learning model, a second forecast value for the variable at the future time point.

3. The method of claim 2, wherein method further comprises:
comparing a difference between the first forecast value and the second forecast value to a threshold difference;
determining whether to output the first forecast value or the second forecast value based upon comparing the difference between the first forecast value and the second forecast value to the threshold difference; and
outputting the determined first forecast value or second forecast value.

4. The method of claim 1, wherein forecasting the plurality of forecast values for the future time point comprises:
predicting that the first forecast value is a change point;
predicting one or more change point attributes of the first forecast value based upon determining that that the first forecast value is a change point; and
predicting the set of one or more forecast attribute values based upon the one or more change point attributes, wherein each forecast attribute values of the set of one or more forecast attributes values describes a change in a respective change point attribute.

5. The method of claim 4, wherein determining the one or more change point attributes of the first forecast value comprises:
predicting a change point type of the first forecast value at the future time point based upon the time series; and
predicting a shift direction of the first forecast value at the future time point based upon the time series and the change point type.

6. The method of claim 1, wherein the first trained machine learning model is a deep learning model that is trained to receive the time series and output the plurality of forecast values based upon the time series.

7. The method of claim 6, wherein the deep learning model is trained by adjusting a plurality of weights of the deep learning model to predict a change point at the future time point, predict a change point type at the future time point, and predict a change point shift direction at the future time point.

8. The method of claim 2, wherein the second trained machine learning model is a regressor model that is trained to receive the plurality of forecast values and output the second forecast value based upon the plurality of forecast values.

9. The method of claim 8, wherein the regressor model is trained by adjusting a plurality of weights of the regressor model to predict the second forecast value based upon the first forecast value, predict a change point type at the future time point, and predict a change point shift direction at the future time point.

10. The method of claim 1, wherein the first trained machine learning model is trained to receive the time series as an analog signal and to output the plurality of forecast values as respective binary values in parallel.

11. A computing system, comprising:
one or more processors; and
a computer-readable medium including instructions that, when executed by the one or more processors, cause the computing system to:
receive a request to predict a value for a variable at a future time point based upon a time series, the time series comprising a sequence of data points, each data point in the sequence of data points identifying a time point and at least one value associated with the time point; and
predict, using a first trained machine learning model and based upon the times series, a plurality of forecast values for the future time point, the plurality of forecast values including:
a first forecast value predicted for the variable at the future time point; and
a set of one or more forecast attribute values for one or more attributes of the time series, each of the set of one or more forecast attribute values predicted for the future time point.

12. The computing system of claim 11, wherein the instructions that, when executed by the one or more processors, further cause the computing system to:
provide the plurality of forecast values as input to a second trained machine learning model; and
predict, using the second trained machine learning model and based upon the plurality of forecast values provided as input to the second trained machine learning model, a second forecast value for the variable at the future time point.

13. The computing system of claim 12, wherein the instructions that, when executed by the one or more processors, further cause the computing system to:
compare a difference between the first forecast value and the second forecast value to a threshold difference;
determine whether to output the first forecast value or the second forecast value based upon comparing the difference between the first forecast value and the second forecast value to the threshold difference; and
output the determined first forecast value or second forecast value.

14. The computing system of claim 11, wherein forecasting the plurality of forecast values for the future time point comprises:
predicting that the first forecast value is a change point;
predicting one or more change point attributes of the first forecast value based upon determining that that the first forecast value is a change point; and
predicting the set of one or more forecast attribute values based upon the one or more change point attributes, wherein each forecast attribute values of the set of one or more forecast attributes values describes a change in a respective change point attribute.

15. The computing system of claim 14, wherein determining the one or more change point attributes of the first forecast value comprises:
predicting a change point type of the first forecast value at the future time point based upon the time series; and
predicting a shift direction of the first forecast value at the future time point based upon the time series and the change point type.

16. One or more non-transitory computer-readable media including stored thereon a sequence of instructions that, when executed by one or more processors, causes a computing system to:
receive a request to predict a value for a variable at a future time point based upon a time series, the time series comprising a sequence of data points, each data point in the sequence of data points identifying a time point and at least one value associated with the time point; and
predicting, using a first trained machine learning model and based upon the times series, a plurality of forecast values for the future time point, the plurality of forecast values including:
a first forecast value predicted for the variable at the future time point; and
a set of one or more forecast attribute values for one or more attributes of the time series, each of the set of one or more forecast attribute values predicted for the future time point.

17. The one or more non-transitory computer-readable media of claim 16, wherein the instructions that, when executed by the one or more processors, further cause the computing system to:
provide the plurality of forecast values as input to a second trained machine learning model; and
predict, using the second trained machine learning model and based upon the plurality of forecast values provided as input to the second trained machine learning model, a second forecast value for the variable at the future time point.

18. The one or more non-transitory computer-readable media of claim 17, wherein the instructions that, when executed by the one or more processors, further cause the computing system to:
compare a difference between the first forecast value and the second forecast value to a threshold difference;
determine whether to output the first forecast value or the second forecast value based upon comparing the difference between the first forecast value and the second forecast value to the threshold difference; and
output the determined first forecast value or second forecast value.

19. The one or more non-transitory computer-readable media of claim 16, wherein forecasting the plurality of forecast values for the future time point comprises:
predicting that the first forecast value is a change point;
predicting one or more change point attributes of the first forecast value based upon determining that that the first forecast value is a change point; and
predicting the set of one or more forecast attribute values based upon the one or more change point attributes, wherein each forecast attribute values of the set of one or more forecast attributes values describes a change in a respective change point attribute.

20. The one or more non-transitory computer-readable media of claim 19, wherein determining the one or more change point attributes of the first forecast value comprises:
predicting a change point type of the first forecast value at the future time point based on the time series; and
predicting a shift direction of the first forecast value at the future time point based upon the time series and the change point type.
